(19) United States
(12) Patent Application Publication
(10) Pub. No.: US 2019/0162619 A1
(43) Pub. Date: May 30, 2019

(54) Physical Quantity Sensor, Physical Quantity Sensor Device, Complex Sensor Device, Electronic Device, And Vehicle

(71) Applicant: Seiko Epson Corporation, Tokyo (JP)

(72) Inventor: Makoto FURUHATA, Matsumoto (JP)

(21) Appl. No.: 16/196,604

(22) Filed: Nov. 20, 2018

(30) Foreign Application Priority Data
Nov. 24, 2017 (JP) 2017-225838

(51) Int. Cl. G01L 19/14; G01P 1/02

(52) U.S. Cl. CPC G01L 19/147; G01P 1/023; G01L 19/148

(57) ABSTRACT

A physical quantity sensor includes a substrate, a sensor element supported on the substrate, and a lid bonded to the substrate so as to store the sensor element between the substrate and the lid. The lid includes a protrusion on the substrate side. The protrusion is disposed not to overlap the sensor element in plan view of the substrate. The protrusion is separated from the substrate or is in contact with the substrate so as to be capable of being separated from the substrate.

### CROSS-REFERENCE TO RELATED APPLICATION

This nonprovisional application claims the benefit of Japanese Patent Application No. 2017-225838 filed Nov. 24, 2017, the entire disclosure of which is incorporated herein by reference.

### BACKGROUND

### 1. Technical Field

The present invention relates to a physical quantity sensor, a physical quantity sensor device, a complex sensor device, an electronic device, and a vehicle.

### 2. Related Art

For example, JP-A-2012-168097 discloses a physical quantity sensor that includes a substrate, a sensor element supported by the substrate, and a lid bonded to the substrate so as to store the sensor element between the lid and the substrate.

However, the physical quantity sensor disclosed in JP-A-2012-168097 has a problem in that the lid is easily bent by stress occurring by an external force, and thus the lid is easily damaged.

### SUMMARY

An advantage of some aspects of the invention is to provide a physical quantity sensor, a physical quantity sensor device, a complex sensor device, an electronic device, and a vehicle in which it is possible to reduce an occurrence of a lid being damaged.

The invention can be implemented as the following configurations.

A physical quantity sensor includes a substrate, a sensor element supported on the substrate, and a lid bonded to the substrate so as to store the sensor element between the substrate and the lid. The lid includes a protrusion on the substrate side. The protrusion is disposed not to overlap the sensor element in plan view of the substrate. The protrusion is separated from the substrate or is in contact with the substrate so as to be separable from the substrate.

With this configuration, the degree of bending deformation of the lid toward the substrate is reduced by the protrusion. Therefore, a physical quantity sensor in which an occurrence of excessive deformation of the lid is reduced, and it is possible to effectively reduce the occurrence of the lid being damaged is obtained.

In the physical quantity sensor, preferably, the lid includes a recess portion which opens to a main surface on the substrate side and in which at least a portion of the sensor element is disposed, and the protrusion is provided on a bottom surface of the recess portion.

With this configuration, it is possible to easily form the protrusion.

In the physical quantity sensor, it is preferable that the protrusion is separated from the substrate.

With this configuration, it is possible to reduce an unintentional occurrence of sticking of the protrusion to the substrate.

In the physical quantity sensor, it is preferable that the distance between the protrusion and the substrate is shorter than the distance between the sensor element and a bottom surface of the recess portion.

With this configuration, if the lid deforms to be bent toward the substrate, the protrusion abuts on the substrate before the bottom surface of the recess portion is brought into contact with the sensor element. Thus, an occurrence of a situation in which the lid deforms to be bent more is reduced. Therefore, it is possible to reduce an occurrence of the sensor element being damaged.

In the physical quantity sensor, it is preferable that the distance between the protrusion and the substrate is from 5 μm to 40 μm.

With this configuration, it is possible to cause the protrusion and the substrate to be sufficiently separated from each other, and to sufficiently reduce the degree of bending deformation of the lid. Therefore, it is possible to more effectively reduce the occurrence of the lid being damaged.

In the physical quantity sensor, it is preferable that the distance between the protrusion and the substrate is from 10 μm to 20 μm.

With this configuration, it is possible to cause the protrusion and the substrate to be sufficiently separated from each other, and to sufficiently reduce the degree of bending deformation of the lid. Therefore, it is possible to more effectively reduce the occurrence of the lid being damaged.

It is preferable that the physical quantity sensor further includes a bonding member that is positioned between the substrate and the lid and bonds the substrate and the lid to each other, and a gap between the protrusion and the substrate is provided by the bonding member.

With this configuration, it is possible to easily form the gap.

In the physical quantity sensor, it is preferable that the protrusion includes a tapered portion having a cross-sectional area which decreases from the lid side toward a tip side.

With this configuration, it is possible to reduce a contact area between the protrusion and the substrate and to effectively reduce the occurrence of sticking of the protrusion to the substrate.

In the physical quantity sensor, it is preferable that a groove portion is provided on a tip surface of the protrusion, which faces the substrate.

With this configuration, it is possible to reduce a contact area between the protrusion and the substrate and to effectively reduce the occurrence of sticking of the protrusion to the substrate.

In the physical quantity sensor, it is preferable that a functional film is provided on a tip surface of the protrusion, which faces the substrate.

With this configuration, it is possible to effectively reduce the occurrence of sticking of the protrusion to the substrate by using a water-repellent film as a functional film, for example.

In the physical quantity sensor, it is preferable that a plurality of protrusions is arranged in the lid.

With this configuration, it is possible to effectively reduce the degree of bending deformation of the lid.

A physical quantity sensor includes a substrate, a sensor element including a fixation portion fixed to the substrate, and a lid bonded to the substrate so as to store the sensor element between the lid and the substrate. The lid includes a protrusion on the substrate side. The protrusion is disposed to overlap the fixation portion in plan view. The protrusion is separated from the fixation portion or is in contact with the fixation portion so as to be separable from the fixation portion.

With this configuration, the degree of bending deformation of the lid toward the substrate is reduced by the protrusion. Therefore, a physical quantity sensor in which an occurrence of excessive deformation of the lid is reduced, and it is possible to effectively reduce the occurrence of the lid being damaged is obtained.

A physical quantity sensor includes a substrate, a sensor element supported on the substrate, a structural member which is supported on the substrate and is disposed not to overlap the sensor element in plan view, and a lid bonded to the substrate so as to store the sensor element and the structural member between the lid and the substrate. The lid includes a protrusion on the substrate side. The protrusion overlaps the structural member in plan view. The protrusion is separated from the structural member or is in contact with the structural member so as to be separable from the structural member.

With this configuration, the degree of bending deformation of the lid toward the substrate is reduced by the protrusion. Therefore, a physical quantity sensor in which an occurrence of excessive deformation of the lid is reduced, and capable of effectively reducing the occurrence of the lid being damaged is obtained.

In the physical quantity sensor, it is preferable that the structural member is disposed to surround at least a portion of the sensor element in plan view.

With this configuration, for example, since the structural member is connected to the ground, it is possible to use structural member as a shield electrode and to block disturbance to be infiltrated into the sensor element.

A physical quantity sensor device includes a physical quantity sensor and a circuit element.

With this configuration, a physical quantity sensor device which is capable of exhibiting the effect of the physical quantity sensor and has high reliability is obtained.

It is preferable that the physical quantity sensor device further includes a package that stores the physical quantity sensor and the circuit element.

With this configuration, it is possible to protect the physical quantity sensor and the circuit element.

A physical quantity sensor device includes a physical quantity sensor and a resin package that covers the physical quantity sensor.

With this configuration, a physical quantity sensor device which is capable of exhibiting the effect of the physical quantity sensor and has high reliability is obtained.

A complex sensor device includes a first physical quantity sensor which is a physical quantity sensor, and a second physical quantity sensor that detects a physical quantity different from that detected by the first physical quantity sensor.

With this configuration, a complex sensor device which is capable of exhibiting the effect of the physical quantity sensor and has high reliability is obtained.

In the complex sensor device, it is preferable that the first physical quantity sensor is a sensor capable of detecting an angular rate, and the second physical quantity sensor is a sensor capable of detecting an acceleration.

With this configuration, a complex sensor device having high convenience is obtained.

An inertial measurement unit includes a physical quantity sensor and a control circuit that controls driving of the physical quantity sensor.

With this configuration, an inertial measurement unit which is capable of exhibiting the effect of the physical quantity sensor and has high reliability is obtained.

A vehicle positioning device includes an inertial measurement unit, a receiving unit (receiver), an acquisition unit, a computation unit, and a calculation unit. The receiving unit (receiver) receives a satellite signal on which position information is superimposed, from a positioning satellite. The acquisition unit acquires the position information in the receiving unit (receiver) based on the received satellite signal. The computation unit computes an attitude of a vehicle based on inertial data output from the inertial measurement unit. The calculation unit calculates the position of the vehicle by correcting the position information based on the computed attitude.

With this configuration, a vehicle positioning device which is capable of exhibiting the effect of the inertial measurement unit and has high reliability is obtained.

A portable electronic device includes a physical quantity sensor, a case in which the physical quantity sensor is accommodated, a processing unit (processor) which is accommodated in the case and processes output data from the physical quantity sensor, a display unit which is accommodated in the case, and a translucent cover that closes an opening portion of the case.

With this configuration, a portable electronic device which is capable of exhibiting the effect of the physical quantity sensor and has high reliability is obtained.

It is preferable that the portable electronic device further includes a satellite positioning system, and measures a distance of a user moving or a movement trajectory.

With this configuration, a portable electronic device having higher convenience is obtained.

An electronic device includes a physical quantity sensor and a control unit (controller) that performs a control based on a detection signal output from the physical quantity sensor.

With this configuration, an electronic device which is capable of exhibiting the effect of the physical quantity sensor and has high reliability is obtained.

A vehicle includes a physical quantity sensor and a control unit (controller) that performs a control based on a detection signal output from the physical quantity sensor.

With this configuration, a vehicle which is capable of exhibiting the effect of the physical quantity sensor and has high reliability is obtained.

It is preferable that the vehicle further includes at least one of an engine system, a brake system, and a keyless entry system, and the control unit (controller) controls the system based on the detection signal.

With this configuration, it is possible to control the system with high precision.

### BRIEF DESCRIPTION OF THE DRAWINGS

The invention will be described with reference to the accompanying drawings, wherein like numbers reference like elements.

FIG. 1 is a plan view illustrating a physical quantity sensor according to a first embodiment.

FIG. 2 is a sectional view taken along line A-A in FIG. 1.

FIG. 3 is a plan view illustrating a sensor element provided in the physical quantity sensor illustrated in FIG. 1.

FIG. 4 is a diagram illustrating a voltage applied to the sensor element.

FIG. 5 is a plan view illustrating a sensor element provided in the physical quantity sensor illustrated in FIG. 1.

FIG. 6 is a plan view illustrating the sensor element provided in the physical quantity sensor illustrated in FIG. 1.

FIG. 7 is a sectional view illustrating a state where stress has been applied to the physical quantity sensor illustrated in FIG. 1.

FIG. 8 is a sectional view illustrating a protrusion provided in a physical quantity sensor according to a second embodiment.

FIG. 9 is a sectional view illustrating a modification example of the protrusion illustrated in FIG. 8.

FIG. 10 is a sectional view illustrating a modification example of the protrusion illustrated in FIG. 8.

FIG. 11 is a sectional view illustrating a modification example of the protrusion illustrated in FIG. 8.

FIG. 12 is a sectional view illustrating protrusion provided in a physical quantity sensor according to a third embodiment.

FIG. 13 is a sectional view illustrating a modification example of the protrusion illustrated in FIG. 12.

FIG. 14 is a sectional view illustrating a protrusion provided in a physical quantity sensor according to a fourth embodiment.

FIG. 15 is a plan view illustrating a physical quantity sensor according to a fifth embodiment.

FIG. 16 is a sectional view illustrating a protrusion provided in a physical quantity sensor according to a sixth embodiment.

FIG. 17 is a plan view illustrating a physical quantity sensor according to a seventh embodiment.

FIG. 18 is a sectional view taken along line B-B in FIG. 17.

FIG. 19 is a sectional view taken along line C-C in FIG. 17.

FIG. 20 is a sectional view taken along line D-D in FIG. 17.

FIG. 21 is a sectional view illustrating a protrusion provided in a physical quantity sensor according to an eighth embodiment.

FIG. 22 is a sectional view illustrating a protrusion provided in a physical quantity sensor according to a ninth embodiment.

FIG. 23 is a sectional view illustrating a protrusion provided in a physical quantity sensor according to a tenth embodiment.

FIG. 24 is a plan view illustrating a physical quantity sensor according to an eleventh embodiment.

FIG. 25 is a sectional view illustrating a physical quantity sensor device according to a twelfth embodiment.

FIG. 26 is a sectional view illustrating a physical quantity sensor device according to a thirteenth embodiment.

FIG. 27 is a sectional view illustrating a physical quantity sensor device according to a fourteenth embodiment.

FIG. 28 is a plan view illustrating a complex sensor device according to a fifteenth embodiment.

FIG. 29 is a sectional view illustrating the complex sensor device illustrated in FIG. 28.

FIG. 30 is an exploded perspective view illustrating an inertial measurement unit according to a sixteenth embodiment.

FIG. 31 is a perspective view illustrating a substrate provided in the inertial measurement unit illustrated in FIG. 30.

FIG. 32 is a block diagram illustrating an entire system of a vehicle positioning device according to a seventeenth embodiment.

FIG. 33 is a diagram illustrating an action of the vehicle positioning device illustrated in FIG. 32.

FIG. 34 is a perspective view illustrating an electronic device according to an eighteenth embodiment.

FIG. 35 is a perspective view illustrating an electronic device according to a nineteenth embodiment.

FIG. 36 is a perspective view illustrating an electronic device according to a twentieth embodiment.

FIG. 37 is a plan view illustrating a portable electronic device according to a twenty-first embodiment.

FIG. 38 is a functional block diagram schematically illustrating a configuration of the portable electronic device illustrated in FIG. 37.

FIG. 39 is a perspective view illustrating a vehicle according to a twenty-second embodiment.

### DESCRIPTION OF EXEMPLARY EMBODIMENTS

Hereinafter, a physical quantity sensor, a physical quantity sensor device, a complex sensor device, an inertial measurement unit, a vehicle positioning device, a portable electronic device, an electronic device, and a vehicle will be described in detail based on embodiments illustrated in the accompanying drawings.

### First Embodiment

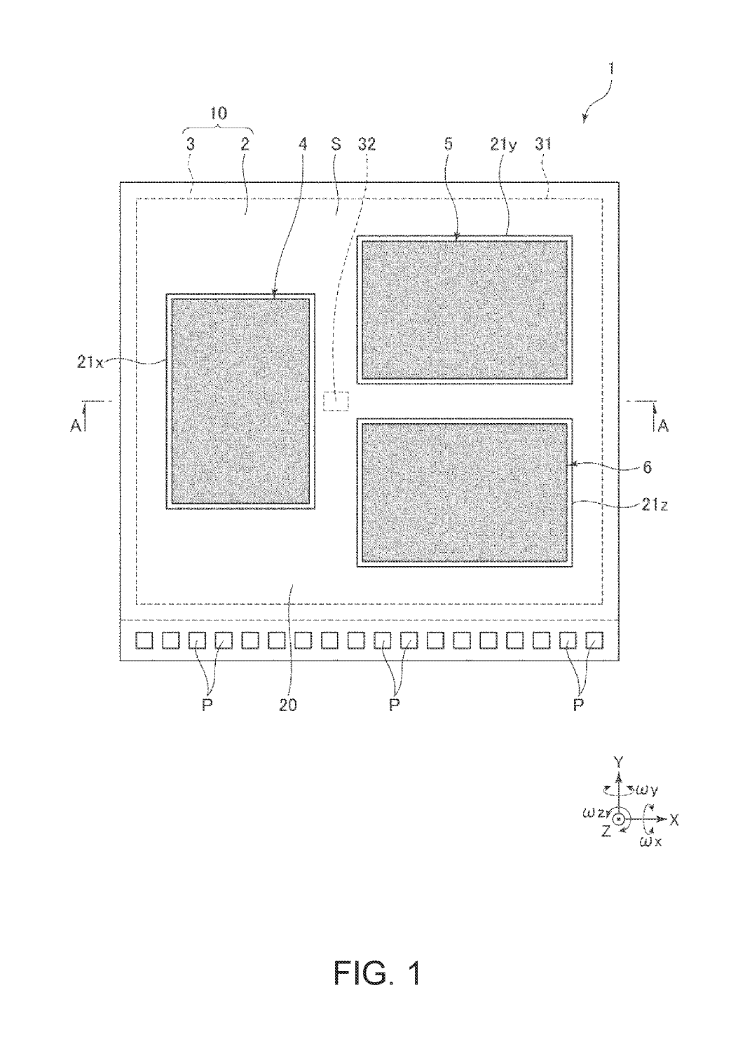

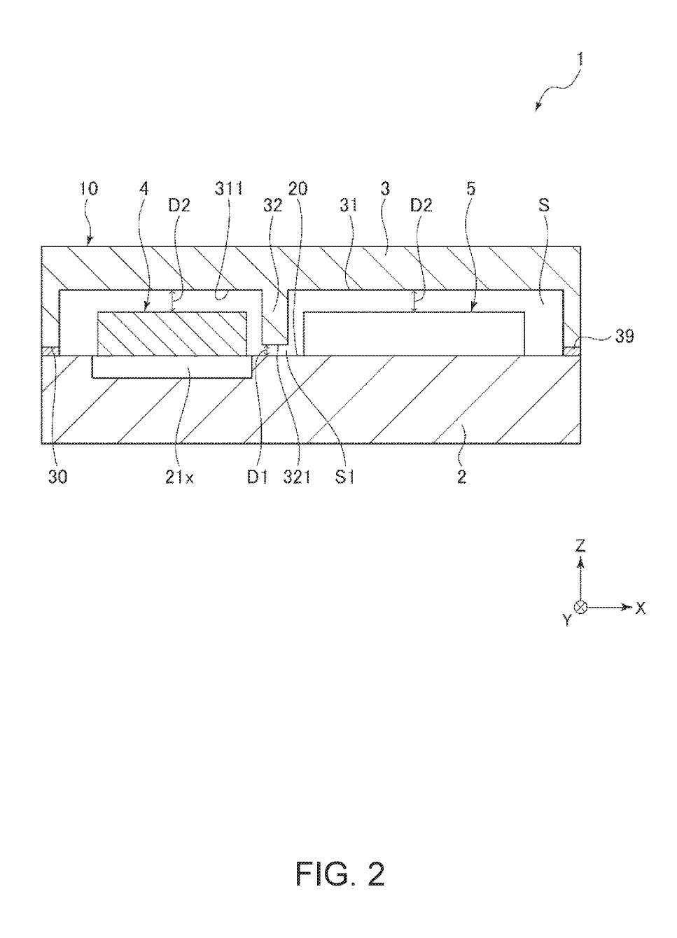

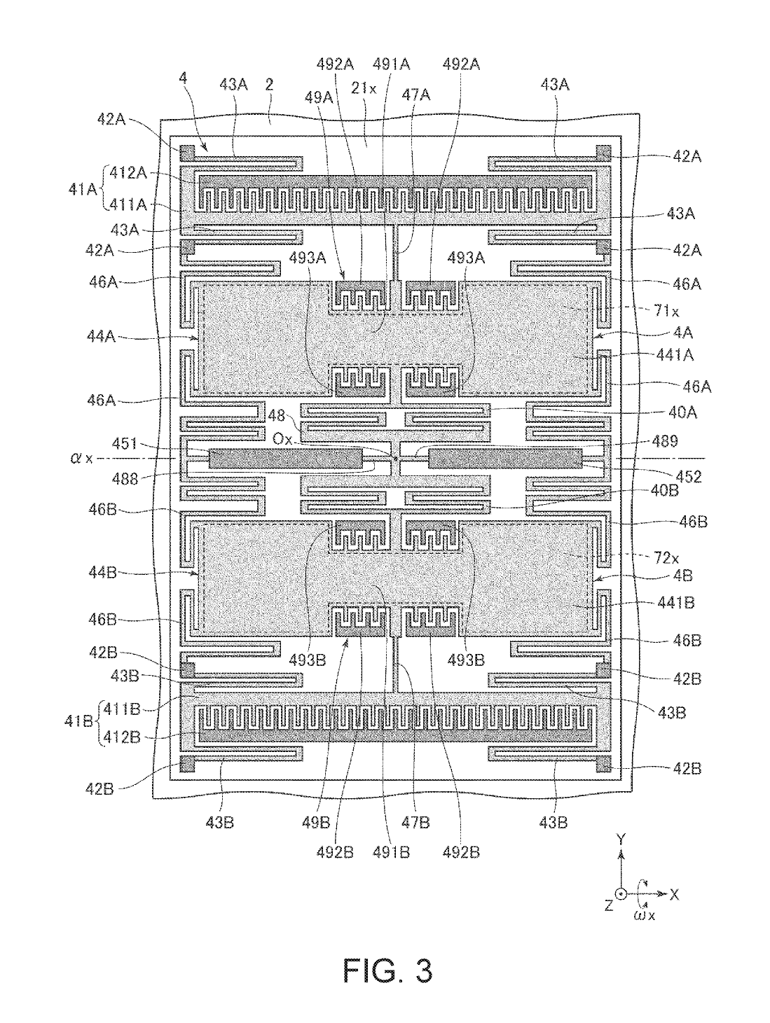

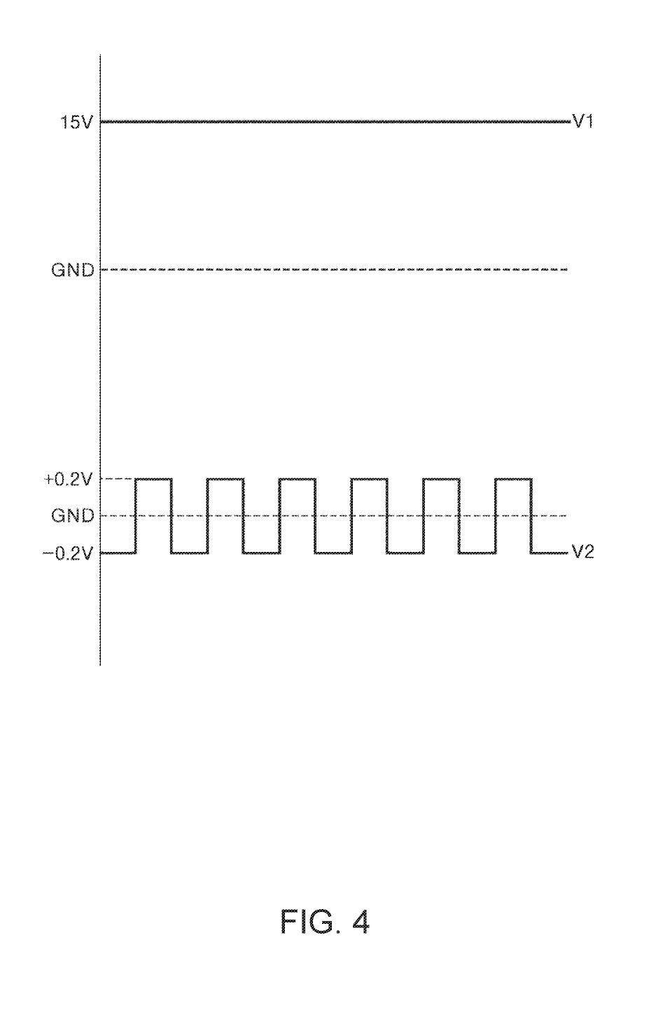

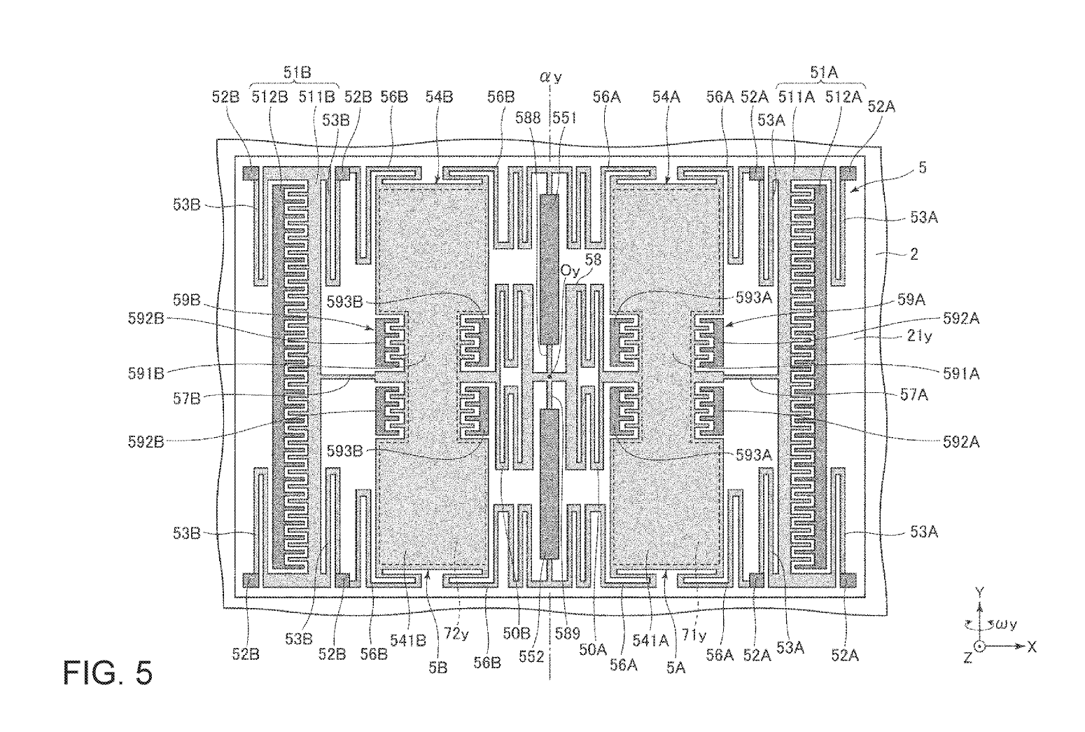

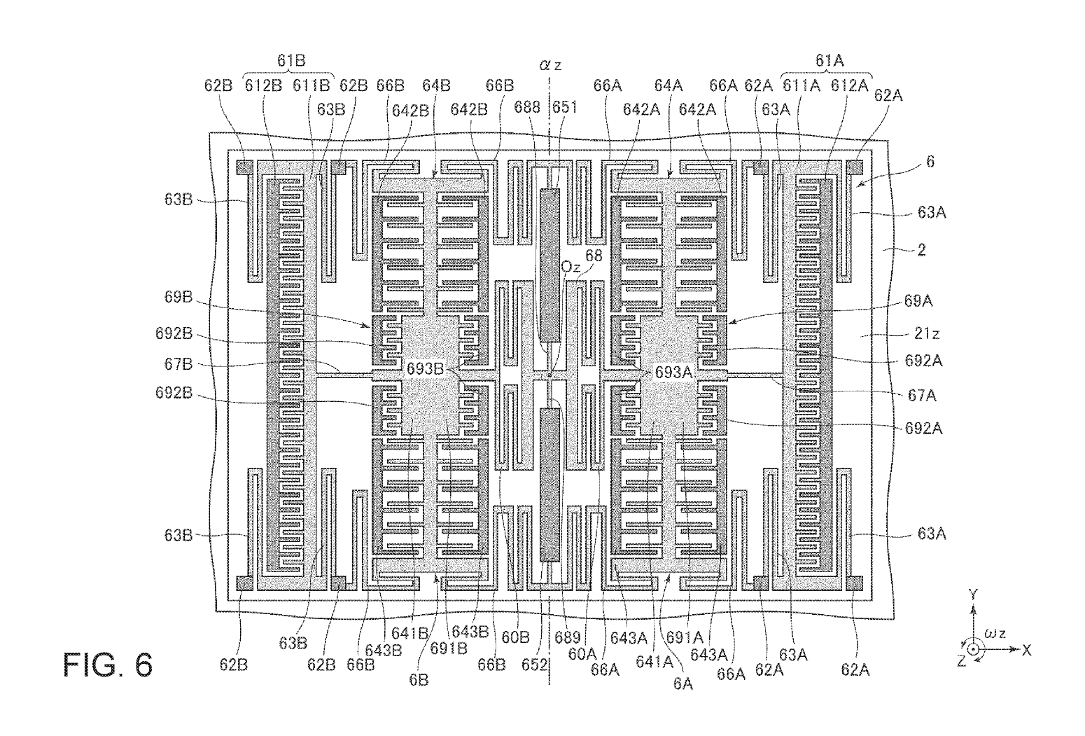

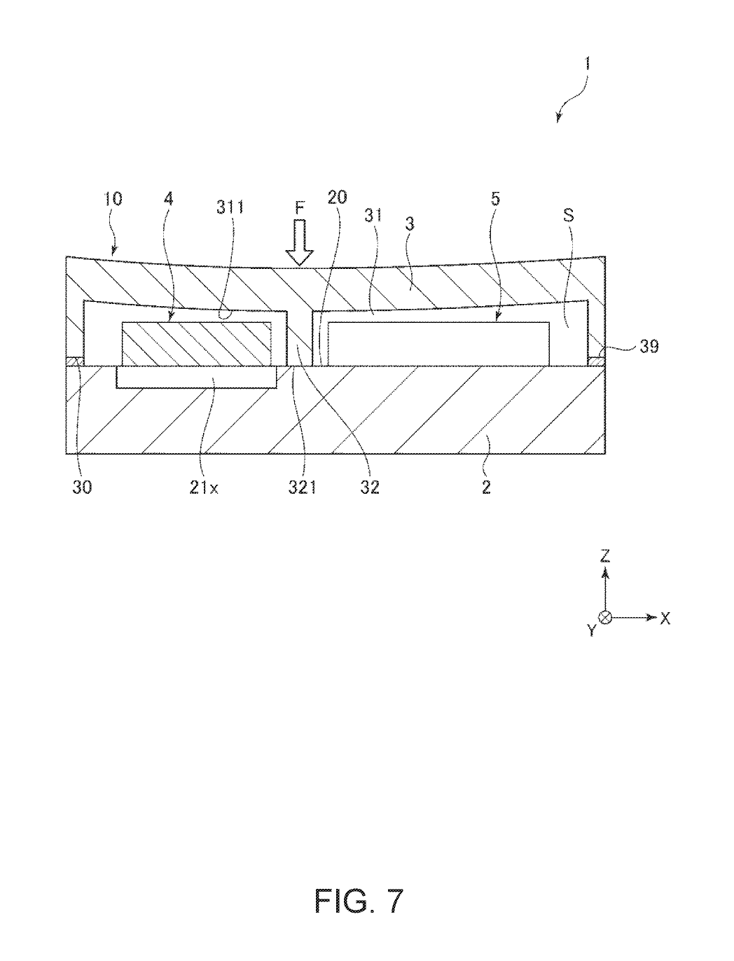

FIG. 1 is a plan view illustrating a physical quantity sensor according to a first embodiment. FIG. 2 is a sectional view taken along line A-A in FIG. 1. FIG. 3 is a plan view illustrating a sensor element provided in the physical quantity sensor illustrated in FIG. 1. FIG. 4 is a diagram illustrating a voltage applied to the sensor element. FIG. 5 is a plan view illustrating a sensor element provided in the physical quantity sensor illustrated in FIG. 1. FIG. 6 is a plan view illustrating a sensor element provided in the physical quantity sensor illustrated in FIG. 1. FIG. 7 is a sectional view illustrating a state where stress has been applied to the physical quantity sensor illustrated in FIG. 1.

For simple descriptions, an X axis, a Y axis, and a Z axis are illustrated as three axes orthogonal to each other, in the drawings. A direction parallel to the X axis is referred to as “an X-axis direction. A direction parallel to the Y axis is referred to as “a Y-axis direction. A direction parallel to the Z axis is referred to as “a Z-axis direction”. A tip side of an arrow indicating each axis direction is referred to as “a positive side”, and a base end side of the arrow is referred to as “a negative side”. A positive side of the Z-axis direction is referred to as “being up”, and a negative side of the Z-axis direction is referred to as “being down”. A state (state viewed in the Z-axis direction) viewed in FIG. 1 is referred to as “plan view”.

A physical quantity sensor 1 illustrated in FIG. 1 is a 3-degrees-of-freedom angular rate sensor capable of detecting an angular rate ωx about the X axis, an angular rate ωy about the Y axis, and an angular rate ωz about the Z axis. Such a physical quantity sensor 1 includes a package 10 and sensor elements 4, 5, and 6 which are stored in the package 10 and have functions different from each other. Regarding the sensor elements 4, 5, and 6, the sensor element 4 detects the angular rate ωx, the sensor element 5 detects the angular rate ωy, and the sensor element 6 detects the angular rate ωz. The number of sensor elements is not particularly limited. At least one sensor element may be provided.

As illustrated in FIGS. 1 and 2, the package 10 includes a substrate 2 and a lid 3 bonded to an upper surface 20 of the substrate 2. As the substrate 2, for example, a glass substrate made of a glass material containing alkali metal ions (for example, borosilicate glass such as Pyrex glass (registered trademark) or Tempax glass (registered trademark)) can be used. As the lid 3, for example, a silicon substrate can be used. The materials for forming the substrate 2 and the lid 3 are not particularly limited, and a silicon substrate, a glass substrate, a ceramic substrate, and the like can be used.

A method of bonding the substrate 2 and the lid 3 to each other is not particularly limited, and may be appropriately selected in accordance with the materials of the substrate 2 and the lid 3. For example, anodic bonding, activated bonding in which bonding surfaces activated by irradiation with plasma are bonded to each other, bonding with a bonding material such as glass frit, and diffusion bonding in which metal films formed on the upper surface 20 of the substrate 2 and a lower surface 30 of the lid 3 are bonded to each other are exemplified. In the embodiment, the substrate 2 and the lid 3 are bonded to each other with glass frit (low-melting glass) 39.

A storage space S of the package 10 is an airtight space. It is preferable that the storage space S is filled with an inert gas such as nitrogen, helium, and argon and is in a decompressed state, in particular, in a vacuum state or in a state close to the vacuum. Thus, viscous resistance is reduced, and it is possible to efficiently drive the sensor elements 4, 5, and 6. An environment of the storage space S is not particularly limited. For example, the storage space S may be in an atmospheric pressure condition.

Recess portions 21x, 21y, and 21z are formed in the upper surface 20 of the substrate 2. The recess portion 21x is disposed to overlap the sensor element 4 in plan view and functions as a clearance portion that prevents a contact of the sensor element 4 and the substrate 2. The recess portion 21y is disposed to overlap the sensor element 5 in plan view and functions as a clearance portion that prevents a contact of the sensor element 5 and the substrate 2. The recess portion 21z is disposed to overlap the sensor element 6 in plan view and functions as a clearance portion that prevents a contact of the sensor element 6 and the substrate 2.

Although not illustrated, a plurality of grooves is formed in the upper surface 20 of the substrate 2. A plurality of wirings which are electrically connected to the sensor element 4, a plurality of wirings which are electrically connected to the sensor element 5, and a plurality of wirings which are electrically connected to the sensor element 6 are arranged in the grooves. The wirings are electrically connected to connection pads P disposed on the outside of the package 10. Therefore, electrical connections with the sensor elements 4, 5, and 6 are allowed through the connection pads P.

Next, the sensor elements 4, 5, and 6 stored in the package 10 will be briefly described. The sensor elements 4, 5, and 6 are bonded to the upper surface 20 of the substrate 2, for example, in a manner of anodic bonding, and can be formed in a manner that a silicon substrate in which impurities such as phosphorus (P), boron (B), and arsenic (As) have been doped is patterned by using a dry etching method (particularly, Bosch method). The materials or the method for forming the sensor elements 4, 5, and 6 is not particularly limited. For example, the sensor elements may be formed, for example, with a semiconductor substrate other than a silicon substrate and may be patterned by wet etching.

Firstly, the sensor element 4 capable of detecting the angular rate ωx will be described. In the following descriptions, in plan view in the Z-axis direction, a straight line which intersects the center Ox of the sensor element 4 and extends in the X-axis direction is also referred to as “a virtual straight line αx”.

As illustrated in FIG. 3, the sensor element 4 has a symmetrical configuration with respect to the virtual straight line αx. The sensor element 4 includes two driving units 41A and 41B disposed on both sides of the virtual straight line αx. The driving unit 41A includes a movable driving electrode 411A having a comb teeth shape and a fixed driving electrode 412A which has a comb teeth shape and is disposed to engage with the movable driving electrode 411A. Similarly, the driving unit 41B includes a movable driving electrode 411B having a comb teeth shape and a fixed driving electrode 412B which has a comb teeth shape and is disposed to engage with the movable driving electrode 411B. Each of the fixed driving electrodes 412A and 412B is bonded to the upper surface of a mount (not illustrated) protruding from the bottom surface of the recess portion 21x and is fixed to the substrate 2.

The sensor element 4 includes four fixation portions 42A arranged around the driving unit 41A and four fixation portions 42B arranged around the driving unit 41B. Each of the fixation portions 42A and 42B is bonded to the upper surface of a mount (not illustrated) protruding from the bottom surface of the recess portion 21x and is fixed to the substrate 2. The sensor element 4 includes four drive springs 43A and four drive springs 43B. The drive springs 43A join the fixation portions 42A to the movable driving electrode 411A, respectively. The drive springs 43B join the fixation portions 42B to the movable driving electrode 411B, respectively.

The sensor element 4 includes a detection unit 44A and a detection unit 44B. The detection unit 44A is positioned between the driving unit 41A and the virtual straight line αx. The detection unit 44B is positioned between the driving unit 41B and the virtual straight line αx. The detection unit 44A is configured with a movable detection electrode 441A having a plate shape. Similarly, the detection unit 44B is configured with a movable detection electrode 441B having a plate shape. A fixed detection electrode 71x facing the movable detection electrode 441A and a fixed detection electrode 72x facing the movable detection electrode 441B are disposed on the bottom surface of the recess portion 21x. When the physical quantity sensor 1 drives, electrostatic capacitance Cxa is formed between the movable detection electrode 441A and the fixed detection electrode 71x, and electrostatic capacitance Cxb is formed between the movable detection electrode 441B and the fixed detection electrode 72x.

The sensor element 4 includes two fixation portions 451 and 452 disposed between the detection units 44A and 44B. Each of the fixation portions 451 and 452 is bonded to the upper surface of a mount (not illustrated) protruding from the bottom surface of the recess portion 21x and is fixed to the substrate 2. The sensor element 4 includes four detection springs 46A and four detection springs 46B. The detection springs 46A join the movable detection electrode 441A to the fixation portions 42A, 451, and 452. The detection springs 46B join the movable detection electrode 441B to the fixation portions 42B, 451, and 452. The sensor element 4 includes a beam 47A and a beam 47B. The beam 47A connects the movable driving electrode 411A and the movable detection electrode 441A. The beam 47B connects the movable driving electrode 411B and the movable detection electrode 441B. In the following descriptions, the assembly of the movable driving electrode 411A, the movable detection electrode 441A, and the beam 47A is also referred to as “a movable body 4A”, and the assembly of the movable driving electrode 411B, the movable detection electrode 441B, and the beam 47B are also referred to as “a movable body 4B”.

For example, if a voltage V1 illustrated in FIG. 4 is applied to the movable bodies 4A and 4B, and a voltage V2 illustrated in FIG. 4 is applied to the fixed driving electrodes 412A and 412B, the movable body 4A and the movable body 4B vibrate in reverse phase in the Y-axis direction by electrostatic attraction acting between the movable body 4A and the movable body 4B (driving vibration mode). If the angular rate ωx is applied to the sensor element 4 in a state where the movable body 4A and the movable body 4B vibrate in reverse phase in the Y-axis direction, as described above, the movable detection electrodes 441A and 441B vibrate in reverse phase in the Z-axis direction by the Coriolis force, and the electrostatic capacitance Cxa and Cxb vary with the vibration (detecting vibration mode). Therefore, the angular rate ωx can be obtained based on the change of the electrostatic capacitance Cxa and Cxb.

As illustrated in FIG. 3, the sensor element 4 includes a frame 48 which is positioned at the center portion and has an “H” shape. The sensor element 4 includes a frame spring 488 connecting the fixation portion 451 and the frame 48 and a frame spring 489 connecting the fixation portion 452 and the frame 48. The sensor element 4 includes a connection spring 40A connecting the frame 48 and the movable detection electrode 441A and a connection spring 40B connecting the frame 48 and the movable detection electrode 441B.

The sensor element 4 includes monitoring units 49A and 49B that detect vibration states of the movable bodies 4A and 4B in the driving vibration mode. The monitoring unit 49A includes a movable monitoring electrode 491A and fixed monitoring electrodes 492A and 493A. The movable monitoring electrode 491A is disposed in the movable detection electrode 441A and has a comb teeth shape. Each of the fixed monitoring electrodes 492A and 493A has a comb teeth shape and is disposed to engage with the movable monitoring electrode 491A. Similarly, the monitoring unit 49B includes a movable monitoring electrode 491B and fixed monitoring electrodes 492B and 493B. The movable monitoring electrode 491B is disposed in the movable detection electrode 441B and has a comb teeth shape. Each of the fixed monitoring electrodes 492B and 493B has a comb teeth shape and is disposed to engage with the movable monitoring electrode 491B. Each of the fixed monitoring electrodes 492A, 493A, 492B, and 493B is bonded to the upper surface of a mount (not illustrated) protruding from the bottom surface of the recess portion 21x and is fixed to the substrate 2.

When the physical quantity sensor 1 drives, electrostatic capacitance Cxc is formed between the movable monitoring electrode 491A and the fixed monitoring electrode 492A and between the movable monitoring electrode 491B and the fixed monitoring electrode 492B. In addition, electrostatic capacitance Cxd is formed between the movable monitoring electrode 491A and the fixed monitoring electrode 493A and between the movable monitoring electrode 491B and the fixed monitoring electrode 493B. In the driving vibration mode, the movable bodies 4A and 4B vibrate in the Y-axis direction. Thus, electrostatic capacitance Cxc and Cxd vary with the vibration. Therefore, it is possible to detect vibration states of the movable bodies 4A and 4B based on the change of the electrostatic capacitance Cxc and Cxd.

Next, the sensor element 5 capable of detecting the angular rate ωy will be described. In the following descriptions, in plan view in the Z-axis direction, a straight line which intersects the center Oy of the sensor element 5 and extends in the Y-axis direction is also referred to as “a virtual straight line αy”. The sensor element 5 has the same configuration as the above-described configuration of the sensor element 4 except that the sensor element 5 is disposed to rotate by 90° around the Z axis.

As illustrated in FIG. 5, the sensor element 5 has a symmetrical configuration with respect to the virtual straight line αy. The sensor element 5 includes two driving units 51A and 51B disposed on both sides of the virtual straight line αy. The driving unit 51A includes a movable driving electrode 511A having a comb teeth shape and a fixed driving electrode 512A which has a comb teeth shape and is disposed to engage with the movable driving electrode 511A. Similarly, the driving unit 51B includes a movable driving electrode 511B having a comb teeth shape and a fixed driving electrode 512B which has a comb teeth shape and is disposed to engage with the movable driving electrode 511B. Each of the fixed driving electrodes 512A and 512B is bonded to the upper surface of a mount (not illustrated) protruding from the bottom surface of the recess portion 21y and is fixed to the substrate 2.

The sensor element 5 includes four fixation portions 52A arranged around the driving unit 51A and four fixation portions 52B arranged around the driving unit 51B. Each of the fixation portions 52A and 52B is bonded to the upper surface of a mount (not illustrated) protruding from the bottom surface of the recess portion 21y and is fixed to the substrate 2. The sensor element 5 includes four drive springs 53A and four drive springs 53B. The drive springs 53A join the fixation portions 52A to the movable driving electrode 511A, respectively. The drive springs 53B join the fixation portions 52B to the movable driving electrode 511B, respectively.

The sensor element 5 includes a detection unit 54A and a detection unit 54B. The detection unit 54A is positioned between the driving unit 51A and the virtual straight line αy. The detection unit 54B is positioned between the driving unit 51B and the virtual straight line αy. The detection unit 54A is configured with a movable detection electrode 541A having a plate shape. Similarly, the detection unit 54B is configured with a movable detection electrode 541B having a plate shape. A fixed detection electrode 71y facing the movable detection electrode 541A and a fixed detection electrode 72y facing the movable detection electrode 541B are disposed on the bottom surface of the recess portion 21y. When the physical quantity sensor 1 drives, electrostatic capacitance Cya is formed between the movable detection electrode 541A and the fixed detection electrode 71y, and electrostatic capacitance Cyb is formed between the movable detection electrode 541B and the fixed detection electrode 72y.

The sensor element 5 includes two fixation portions 551 and 552 disposed between the detection units 54A and 54B. Each of the fixation portions 551 and 552 is bonded to the upper surface of a mount (not illustrated) protruding from the bottom surface of the recess portion 21y and is fixed to the substrate 2. The sensor element 5 includes four detection springs 56A and four detection springs 56B. The detection springs 56A join the movable detection electrode 541A to the fixation portions 52A, 551, and 552. The detection springs 56B join the movable detection electrode 541B to the fixation portions 52B, 551, and 552. The sensor element 5 includes a beam 57A and a beam 57B. The beam 57A connects the movable driving electrode 511A and the movable detection electrode 541A. The beam 57B connects the movable driving electrode 511B and the movable detection electrode 541B. In the following descriptions, the assembly of the movable driving electrode 511A, the movable detection electrode 541A, and the beam 57A is also referred to as “a movable body 5A”, and the assembly of the movable driving electrode 511B, the movable detection electrode 541B, and the beam 57B are also referred to as “a movable body 5B”.

For example, if the voltage V1 illustrated in FIG. 4 is applied to the movable bodies 5A and 5B, and the voltage V2 illustrated in FIG. 4 is applied to the fixed driving electrodes 512A and 512B, the movable body 5A and the movable body 5B vibrate in reverse phase in the X-axis direction by electrostatic attraction acting between the movable body 5A and the movable body 5B (driving vibration mode). If the angular rate ωy is applied to the sensor element 5 in a state where the movable body 5A and the movable body 5B vibrate in reverse phase in the X-axis direction, as described above, the movable detection electrodes 541A and 541B vibrate in reverse phase in the Z-axis direction by the Coriolis force, and the electrostatic capacitance Cya and Cyb vary with the vibration (detecting vibration mode). Therefore, the angular rate ωy can be obtained based on the change of the electrostatic capacitance Cya and Cyb.

As illustrated in FIG. 5, the sensor element 5 includes a frame 58 which is positioned at the center portion and has an “H” shape. The sensor element 5 includes a frame spring 588 connecting the fixation portion 551 and the frame 58 and a frame spring 589 connecting the fixation portion 552 and the frame 58. The sensor element 5 includes a connection spring 50A connecting the frame 58 and the movable detection electrode 541A and a connection spring 50B connecting the frame 58 and the movable detection electrode 541B.

The sensor element 5 includes monitoring units 59A and 59B that detect vibration states of the movable bodies 5A and 5B in the driving vibration mode. The monitoring unit 59A includes a movable monitoring electrode 591A and fixed monitoring electrodes 592A and 593A. The movable monitoring electrode 591A is disposed in the movable detection electrode 541A and has a comb teeth shape. Each of the fixed monitoring electrodes 592A and 593A has a comb teeth shape and is disposed to engage with the movable monitoring electrode 591A. Similarly, the monitoring unit 59B includes a movable monitoring electrode 591B and fixed monitoring electrodes 592B and 593B. The movable monitoring electrode 591B is disposed in the movable detection electrode 541B and has a comb teeth shape. Each of the fixed monitoring electrodes 592B and 593B has a comb teeth shape and is disposed to engage with the movable monitoring electrode 591B. Each of the fixed monitoring electrodes 592A, 593A, 592B, and 593B is bonded to the upper surface of a mount (not illustrated) protruding from the bottom surface of the recess portion 21y and is fixed to the substrate 2.

When the physical quantity sensor 1 drives, electrostatic capacitance Cyc is formed between the movable monitoring electrode 591A and the fixed monitoring electrode 592A and between the movable monitoring electrode 591B and the fixed monitoring electrode 592B. In addition, electrostatic capacitance Cyd is formed between the movable monitoring electrode 591A and the fixed monitoring electrode 593A and between the movable monitoring electrode 591B and the fixed monitoring electrode 593B. In the driving vibration mode, the movable bodies 5A and 5B vibrate in the X-axis direction. Thus, electrostatic capacitance Cyc and Cyd vary with the vibration. Therefore, it is possible to detect vibration states of the movable bodies 5A and 5B based on the change of the electrostatic capacitance Cyc and Cyd.

Next, the sensor element 6 capable of detecting the angular rate ωz will be described. In the following descriptions, in plan view in the Z-axis direction, a straight line which intersects the center Oz of the sensor element 6 and extends in the Y-axis direction is also referred to as “a virtual straight line αz”.

As illustrated in FIG. 6, the sensor element 6 has a symmetrical configuration with respect to the virtual straight line αz. The sensor element 6 includes two driving units 61A and 61B disposed on both sides of the virtual straight line αz. The driving unit 61A includes a movable driving electrode 611A having a comb teeth shape and a fixed driving electrode 612A which has a comb teeth shape and is disposed to engage with the movable driving electrode 611A. Similarly, the driving unit 61B includes a movable driving electrode 611B having a comb teeth shape and a fixed driving electrode 612B which has a comb teeth shape and is disposed to engage with the movable driving electrode 611B. Each of the fixed driving electrodes 612A and 612B is bonded to the upper surface of a mount (not illustrated) protruding from the bottom surface of the recess portion 21z and is fixed to the substrate 2.

The sensor element 6 includes four fixation portions 62A arranged around the driving unit 61A and four fixation portions 62B arranged around the driving unit 61B. Each of the fixation portions 62A and 62B is bonded to the upper surface of a mount (not illustrated) protruding from the bottom surface of the recess portion 21z and is fixed to the substrate 2. The sensor element 6 includes four drive springs 63A and four drive springs 63B. The drive springs 63A join the fixation portions 62A to the movable driving electrode 611A, respectively. The drive springs 63B join the fixation portions 62B to the movable driving electrode 611B, respectively.

The sensor element 6 includes a detection unit 64A and a detection unit 64B. The detection unit 64A is positioned between the driving unit 61A and the virtual straight line αz. The detection unit 64B is positioned between the driving unit 61B and the virtual straight line αz. The detection unit 64A includes a movable detection electrode 641A having a comb teeth shape and fixed detection electrodes 642A and 643A. Each of the fixed detection electrodes 642A and 643A has a comb teeth shape and is disposed to engage with the movable detection electrode 641A. Similarly, the detection unit 64B includes a movable detection electrode 641B having a comb teeth shape and fixed detection electrodes 642B and 643B. Each of the fixed detection electrodes 642B and 643B has a comb teeth shape and is disposed to engage with the movable detection electrode 641B. Each of the fixed detection electrodes 642A, 643A, 642B, and 643B is bonded to the upper surface of a mount (not illustrated) protruding from the bottom surface of the recess portion 21z and is fixed to the substrate 2. When the physical quantity sensor 1 drives, electrostatic capacitance Cza is formed between the movable detection electrode 641A and the fixed detection electrode 642A and between the movable detection electrode 641B and the fixed detection electrode 643B. In addition, electrostatic capacitance Czb is formed between the movable detection electrode 641A and the fixed detection electrode 643A and between the movable detection electrode 641B and the fixed detection electrode 642B.

The sensor element 6 includes two fixation portions 651 and 652 disposed between the detection units 64A and 64B. Each of the fixation portions 651 and 652 is bonded to the upper surface of a mount (not illustrated) protruding from the bottom surface of the recess portion 21z and is fixed to the substrate 2. The sensor element 6 includes four detection springs 66A and four detection springs 66B. The detection springs 66A join the movable detection electrode 641A to the fixation portions 62A, 651, and 652. The detection springs 66B join the movable detection electrode 641B to the fixation portions 62B, 651, and 652. The sensor element 6 includes a beam 67A and a beam 67B. The beam 67A connects the movable driving electrode 611A and the movable detection electrode 641A. The beam 67B connects the movable driving electrode 611B and the movable detection electrode 641B. In the following descriptions, the assembly of the movable driving electrode 611A, the movable detection electrode 641A, and the beam 67A is also referred to as “a movable body 6A”, and the assembly of the movable driving electrode 611B, the movable detection electrode 641B, and the beam 67B are also referred to as “a movable body 6B”.

For example, if the voltage V1 illustrated in FIG. 4 is applied to the movable bodies 6A and 6B, and the voltage V2 illustrated in FIG. 4 is applied to the fixed driving electrodes 612A and 612B, the movable body 6A and the movable body 6B vibrate in reverse phase in the X-axis direction by electrostatic attraction acting between the movable body 6A and the movable body 6B (driving vibration mode). If the angular rate ωz is applied to the sensor element 6 in a state where the movable body 6A and the movable body 6B vibrate in reverse phase in the X-axis direction, as described above, the movable detection electrodes 641A and 641B vibrate in reverse phase in the Y-axis direction by the Coriolis force, and the electrostatic capacitance Cza and Czb vary with the vibration (detecting vibration mode). Therefore, the angular rate ωz can be obtained based on the change of the electrostatic capacitance Cza and Czb.

As illustrated in FIG. 6, the sensor element 6 includes a frame 68 which is positioned at the center portion and has an “H” shape. The sensor element 6 includes a frame spring 688 connecting the fixation portion 651 and the frame 68 and a frame spring 689 connecting the fixation portion 652 and the frame 68. The sensor element 6 includes a connection spring 60A connecting the frame 68 and the movable detection electrode 641A and a connection spring 60B connecting the frame 68 and the movable detection electrode 641B.

The sensor element 6 includes monitoring units 69A and 69B that detect vibration states of the movable bodies 6A and 6B in the driving vibration mode. The monitoring unit 69A includes a movable monitoring electrode 691A and fixed monitoring electrodes 692A and 693A. The movable monitoring electrode 691A is disposed in the movable detection electrode 641A and has a comb teeth shape. Each of the fixed monitoring electrodes 692A and 693A has a comb teeth shape and is disposed to engage with the movable monitoring electrode 691A. Similarly, the monitoring unit 69B includes a movable monitoring electrode 691B and fixed monitoring electrodes 692B and 693B. The movable monitoring electrode 691B is disposed in the movable detection electrode 641B and has a comb teeth shape. Each of the fixed monitoring electrodes 692B and 693B has a comb teeth shape and is disposed to engage with the movable monitoring electrode 691B. Each of the fixed monitoring electrodes 692A, 693A, 692B, and 693B is bonded to the upper surface of a mount (not illustrated) protruding from the bottom surface of the recess portion 21z and is fixed to the substrate 2.

When the physical quantity sensor 1 drives, electrostatic capacitance Czc is formed between the movable monitoring electrode 691A and the fixed monitoring electrode 692A and between the movable monitoring electrode 691B and the fixed monitoring electrode 692B. In addition, electrostatic capacitance Czd is formed between the movable monitoring electrode 691A and the fixed monitoring electrode 693A and between the movable monitoring electrode 691B and the fixed monitoring electrode 693B. In the driving vibration mode, the movable bodies 6A and 6B vibrate in the X-axis direction. Thus, electrostatic capacitance Czc and Czd vary with the vibration. Therefore, it is possible to detect vibration states of the movable bodies 6A and 6B based on the change of the electrostatic capacitance Czc and Czd.

Hitherto, the entire configuration of the physical quantity sensor 1 is described. Next, a configuration of the lid 3 will be described in detail. As illustrated in FIG. 2, the lid 3 includes a recess portion 31 opening to the lower surface 30, and the recess portion 31 forms a portion of the storage space S that stores the sensor elements 4, 5, and 6. The lid 3 includes a columnar protrusion 32 that protrudes from a bottom surface 311 (upper surface in FIG. 2) of the recess portion 31 toward the substrate 2 side (downwardly). A tip surface 321 (lower surface in FIG. 2) of the protrusion 32 is flush (has the same height in an up-and-down direction in FIG. 2) with the lower surface 30 (bonded surface to the glass frit 39) of the lid 3. The tip surface 321 of the protrusion 32 may be positioned above the lower surface 30 of the lid 3 (that is, in the recess portion 31) or may be positioned below the lower surface 30.

The protrusion 32 has a columnar shape having a cross-sectional area which is substantially constant along the Z-axis direction. As illustrated in FIG. 1, the shape of the cross-section of the protrusion 32 is substantially a square. However, the shape of the protrusion 32 is not particularly limited. Any shape, for example, a circle, an ellipse, a semicircle, a triangle, a rectangle, a quadrangle such as a parallelogram except for a square, and a polygon being a pentagon or more may be provided as the shape of the cross-section of the protrusion 32.

As illustrated in FIGS. 1 and 2, the protrusion 32 is disposed not to overlap any of the sensor elements 4, 5, and 6 in plan view in the Z-axis direction. Thus, it is possible to prevent a contact of the protrusion 32 with the sensor elements 4, 5, and 6, and to reduce an occurrence of a situation in which the protrusion 32 hinders driving of the sensor elements 4, 5, and 6 or the sensor elements 4, 5, and 6 are damaged. As illustrated in FIG. 2, the protrusion 32 is disposed to be separated from the substrate 2 such that the tip surface 321 of the protrusion is not brought into contact with the upper surface 20 of the substrate 2. That is, a gap S1 is formed between the tip surface 321 of the protrusion 32 and the upper surface 20 of the substrate 2. Since the protrusion 32 is provided in this manner, for example, as illustrated in FIG. 7, even though the lid 3 deforms to be bent downward by stress F applied from the upper part, the tip surface 321 of the protrusion 32 abuts on the upper surface 20 of the substrate 2 at an initial stage of the deformation, and thus downward bending deformation of the lid 3 occurs no more. That is, the protrusion 32 functions as a stopper of bending deformation of the lid 3 occurring by stress F. Therefore, it is possible to reduce an occurrence of excessive deformation of the lid 3 and to effectively reduce the damage of the lid 3. In addition, it is possible to reduce an occurrence of a situation in which the lid 3 is brought into contact with the sensor element 4, 5, or 6 and thus the sensor element 4, 5, or 6 is damaged.

Even with a configuration in which the tip surface 321 of the protrusion 32 is bonded to the upper surface 20 of the substrate 2 through the glass frit 39, it is possible to reduce the occurrence of excessive deformation of the lid 3, similar to the embodiment. However, if the tip surface 321 of the protrusion 32 is bonded to the upper surface 20 of the substrate 2, an area in which the substrate 2 and the lid 3 are bonded to each other increases by the degree of being bonded. Thus, thermal stress occurring in the package 10 due to a difference of a thermal expansion coefficient between the substrate 2 and the lid 3 increases. Therefore, thermal stress to be transferred to the sensor element 4, 5, or 6 increases, and angular-rate detection characteristics (particularly, temperature characteristics) of the sensor elements 4, 5, and 6 decrease. On the contrary, if the tip surface 321 of the protrusion 32 is separated from the upper surface 20 of the substrate 2 as in the embodiment, the area in which the substrate 2 and the lid 3 are bonded to each other does not increase. Thus, it is possible to suppress the above-described thermal stress small. Therefore, it is possible to effectively reduce an increase of thermal stress to be transferred to the sensor element 4, 5, or 6, and to effectively reduce a decrease of the angular-rate detection characteristics (particularly, temperature characteristics) of the sensor elements 4, 5, and 6.

The position of the protrusion 32 as described above is not particularly limited. The protrusion 32 is preferably positioned on an inner side of the outer circumferential portion (outer circumferential wall) of the lid 3, and particularly preferably positioned at the center portion of the storage space S. Thus, it is possible to effectively reduce the downward bending deformation of the lid 3. In the embodiment, as illustrated in FIG. 1, the protrusion 32 is positioned between the sensor elements 4, 5, and 6 so as to avoid the sensor elements 4, 5, and 6 in plan view in the Z-axis direction. The protrusion 32 is positioned substantially at the center of the storage space S.

As illustrated in FIG. 2, a distance D1 between the tip surface 321 of the protrusion 32 and the upper surface 20 of the substrate 2 is smaller than a distance D2 between the upper surfaces of the sensor elements 4, 5, and 6 and the bottom surface 311 of the recess portion 31. That is, D1<D2 is satisfied. Thus, if the lid 3 deforms to be bent downward, the tip surface 321 of the protrusion 32 abuts on the upper surface 20 of the substrate 2 before the bottom surface 311 is brought into contact with the sensor elements 4, 5, and 6. Thus, the downward bending deformation of the lid 3 occurs no more. Therefore, it is possible to more reliably reduce an occurrence of a contact of the lid 3 with the sensor elements 4, 5, and 6. The distance D1 is not particularly limited. For example, the distance D1 is preferably from 5 μm to 40 μm, and more preferably from 10 μm to 20 μm. Thus, it is possible to cause the tip surface 321 and the upper surface 20 to be sufficiently separated from each other, and to sufficiently suppress the degree of bending deformation of the lid 3. Therefore, it is possible to more effectively reduce the damage of the lid 3 or the sensor elements 4, 5, and 6.

Here, as described above, the glass frit 39 is provided between the substrate 2 and the lid 3 at the outer circumferential portion of the package 10, and the substrate 2 and the lid 3 are bonded to each other by the glass frit 39. The tip surface 321 of the protrusion 32 is flush with the lower surface 30 (bonded surface to the glass frit 39) of the lid 3. Therefore, the glass frit 39 forms the gap S1 as long as the thickness of the glass frit. Accordingly, the glass frit 39 functions as a bonding member that bonds the substrate 2 and the lid 3 to each other, and functions as a spacer for forming the gap S1 between the tip surface 321 of the protrusion 32 and the upper surface 20 of the substrate 2. According to such a configuration, when the substrate 2 and the lid 3 are bonded to each other, the gap S1 is simultaneously formed. Thus, it is possible to simplify a manufacturing process of the physical quantity sensor 1. It is possible to adjust the distance D1, for example, by controlling the thickness of the glass frit 39. Thus, dimension precision of the distance D1 is improved.

Hitherto, the physical quantity sensor 1 is described. As described above, such a physical quantity sensor 1 includes the substrate 2, the sensor elements 4, 5, and 6 supported on the substrate 2, and the lid 3 bonded to the substrate 2 so as to store the sensor elements 4, 5, and 6 between the substrate 2 and the lid 3. The lid 3 includes the protrusion 32 on the substrate 2 side. The protrusion 32 is disposed not to overlap the sensor elements 4, 5, and 6 in plan view of the substrate 2 and is separated from the substrate 2 (upper surface 20). Thus, for example, even though the lid 3 deforms to be bent toward the substrate 2, the protrusion 32 abuts on (is brought into contact with) the substrate 2 at the initial state of the deformation, and thus the downward bending deformation of the lid 3 occurs no more. Therefore, it is possible to reduce an occurrence of excessive deformation of the lid 3 and to effectively reduce the damage of the lid 3. In addition, it is possible to reduce an occurrence of a situation in which the lid 3 is brought into contact with the sensor element 4, 5, or 6 and thus the sensor element 4, 5, or 6 is damaged. Since the protrusion 32 is separated from the substrate 2, it is possible to reduce an occurrence of a situation in which the protrusion 32 unintentionally sticks to the substrate 2.

As described above, the lid 3 opens to the lower surface 30 (main surface on the substrate 2) and includes the recess portion 31 in which at least a portion of the sensor elements 4, 5, and 6 is disposed. The protrusion 32 is provided on the bottom surface 311 of the recess portion 31. Thus, it is possible to simply form the protrusion 32 in the lid, for example, by etching (dry etching or wet etching).

As described above, the distance D1 between the protrusion 32 and the substrate 2 is smaller than the distance D2 between the sensor elements 4, 5, and 6 and the bottom surface 311 of the recess portion 31. Thus, if the lid 3 deforms to be bent toward the substrate 2, the tip surface 321 of the protrusion 32 abuts on the upper surface of the substrate 2 before the bottom surface 311 is brought into contact with the sensor elements 4, 5, and 6. Thus, the occurrence of a situation in which the lid 3 deforms to be bent more is reduced. Therefore, it is possible to more reliably reduce an occurrence of a contact of the lid 3 with the sensor elements 4, 5, and 6.

As described above, the distance D1 between the protrusion 32 and the substrate 2 is preferably from 5 to 40 μm and more preferably from 10 μm to 20 μm. Thus, it is possible to cause the protrusion 32 and the substrate 2 to be sufficiently separated from each other, and to sufficiently suppress the degree of bending deformation of the lid 3 small. Therefore, it is possible to more effectively reduce the damage of the lid 3 or the sensor elements 4, 5, and 6.

As described above, the physical quantity sensor includes the glass frit (bonding member) 39 that is positioned between the substrate 2 and the lid 3 and bonds the substrate 2 and the lid 3 to each other. The gap S1 is provided between the protrusion 32 and the substrate 2 by the glass frit 39. According to such a configuration, when the substrate 2 and the lid 3 are bonded to each other, the gap S1 is simultaneously formed. Thus, it is possible to simplify a manufacturing process of the physical quantity sensor 1. It is possible to adjust the distance D1, for example, by controlling the thickness of the glass frit 39. Thus, dimension precision of the distance D1 is improved.

### Second Embodiment

Next, a physical quantity sensor according to a second embodiment will be described.

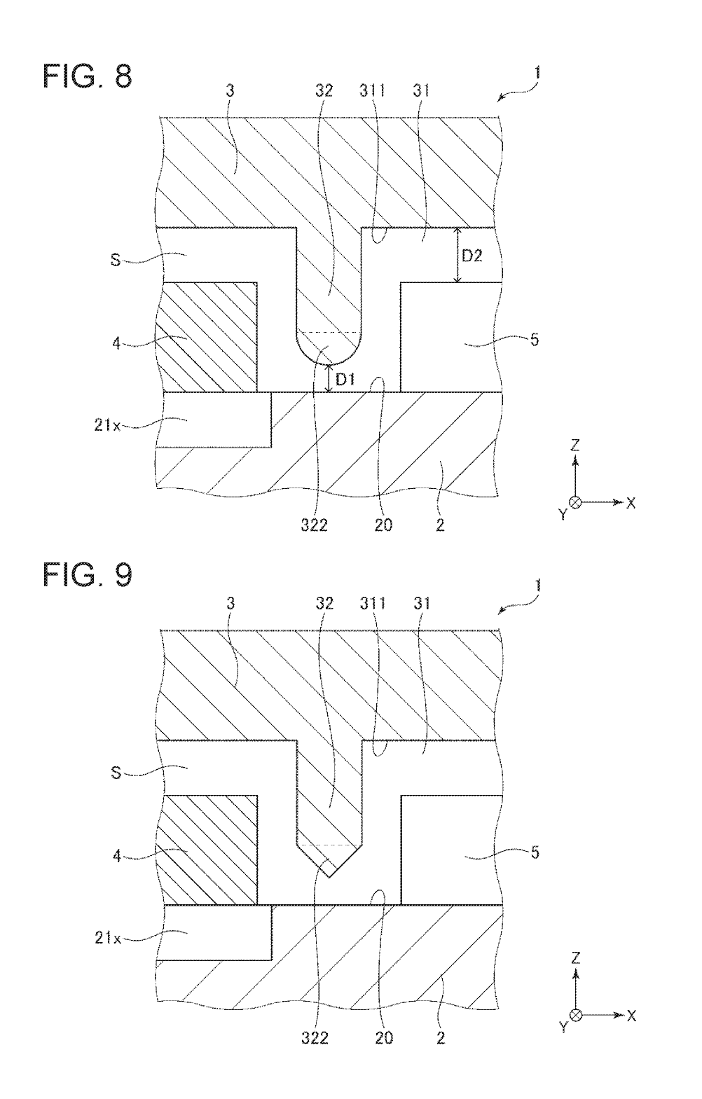

FIG. 8 is a sectional view illustrating a protrusion provided in the physical quantity sensor according to the second embodiment. FIGS. 9 to 11 are sectional views illustrating modification examples of the protrusion illustrated in FIG. 8. FIGS. 8 to 11 are views corresponding to the sectional view taken along line A-A in FIG. 1, similar to FIG. 2.

A physical quantity sensor 1 in this embodiment is similar to the above-described physical quantity sensor 1 according to the first embodiment except that the shape of a protrusion 32 is different from that in the first embodiment. In the following descriptions, the physical quantity sensor 1 in the second embodiment will be described focusing on a difference from the above-described first embodiment, and descriptions of the similar items will not be repeated. In FIG. 8, the same components as those in the above-described first embodiment are denoted by the same reference signs.

As illustrated in FIG. 8, the protrusion 32 in this embodiment includes a tapered portion 322 at a tip portion of the protrusion 32. The tapered portion 322 has a cross-sectional area decreasing from the lid 3 side toward the tip side. In particular, in this embodiment, the tip portion is rounded in a spherical shape. Thus, for example, in comparison to the above-described first embodiment, a situation in which the tip portion of the protrusion 32 is chipped at time of contact with the substrate 2 occurs less frequently, and it is possible to effectively reduce the damage of the protrusion 32. In addition, for example, in comparison to the above-described first embodiment, the contact area between the protrusion 32 and the substrate 2 is reduced. Thus, it is possible to effectively reduce an occurrence of so-called “sticking” which is a phenomenon in which the protrusion 32 sticks to the substrate 2 when the protrusion 32 and the substrate 2 are brought into contact with each other.

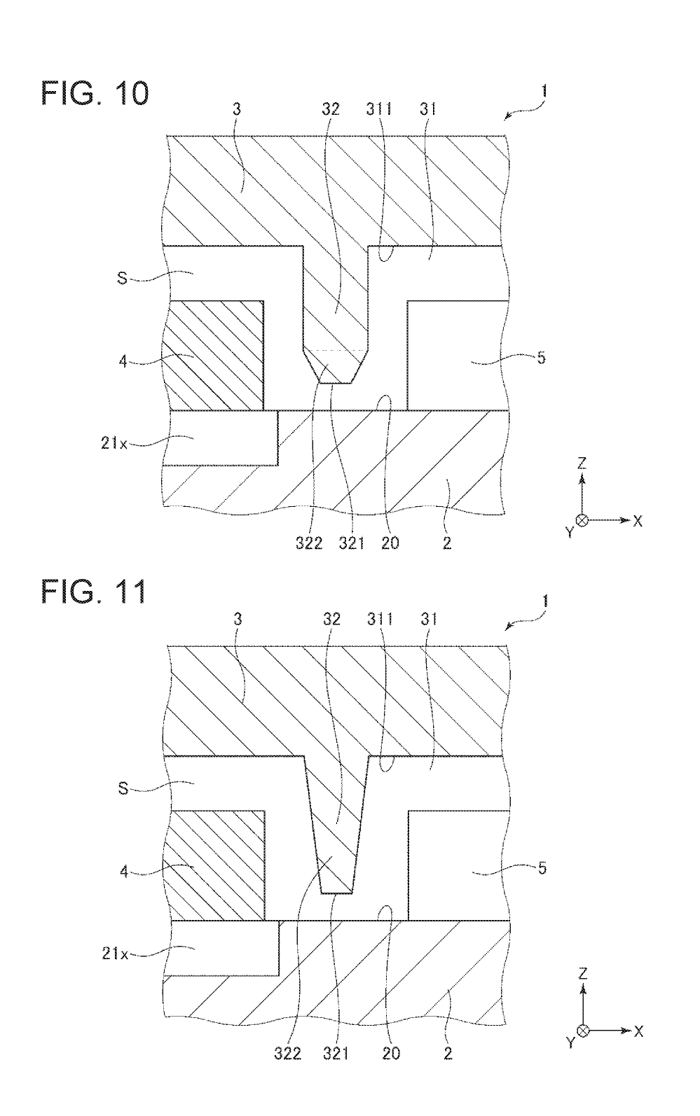

With such a second embodiment, it is also possible to exhibit effects similar to those in the above-described first embodiment. The shape of the tapered portion 322 is not limited to those in this embodiment, and any shape may be provided. For example, as illustrated in FIG. 9, the tapered portion 322 may be a hornlike shape (for example, conical shape, triangular pyramidal shape, square pyramidal shape, and a pyramidal shape being pentagonal or more). As illustrated in FIG. 10, the tapered portion 322 may be a truncated hornlike shape (for example, truncated conical shape, truncated triangular-pyramidal shape, truncated square-pyramidal shape, and truncated pyramidal shape being pentagonal or more). As illustrated in FIG. 11, the entirety of the protrusion 32 in an axis direction may be formed as the tapered portion 322.

### Third Embodiment

Next, a physical quantity sensor according to a third embodiment will be described.

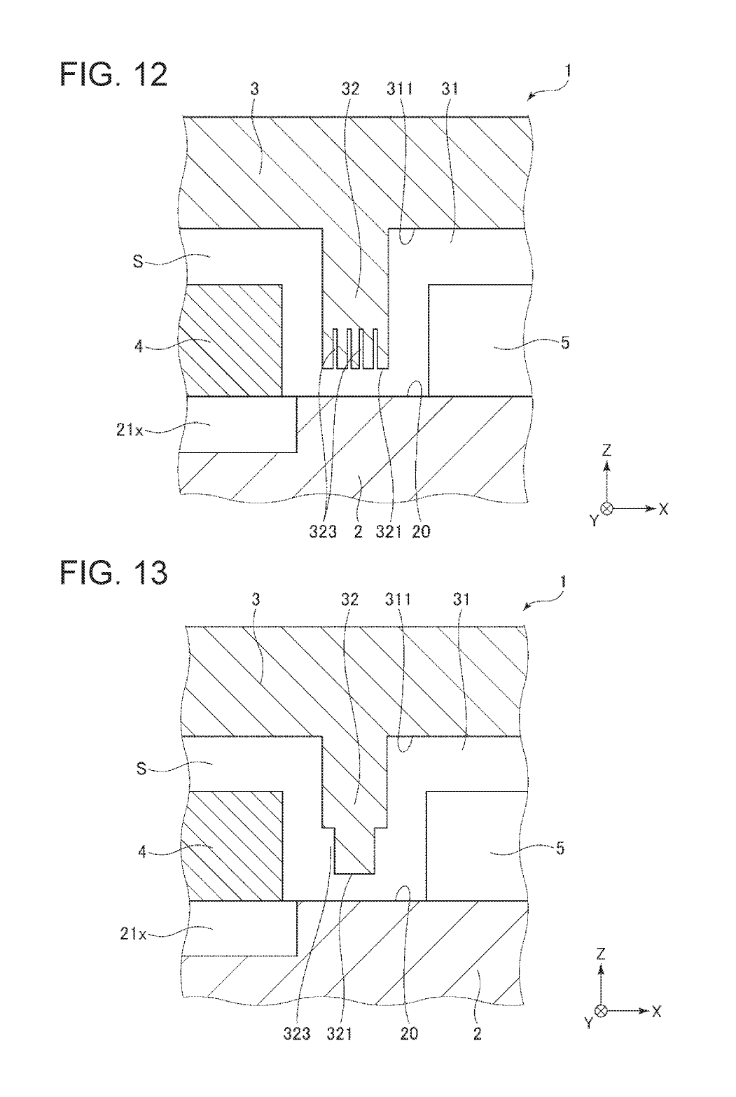

FIG. 12 is a sectional view illustrating a protrusion provided in the physical quantity sensor according to the third embodiment. FIG. 13 is a sectional view illustrating a modification example of the protrusion illustrated in FIG. 12. FIGS. 12 and 13 are views corresponding to the sectional view taken along line A-A in FIG. 1, similar to FIG. 2.

A physical quantity sensor 1 in this embodiment is similar to the above-described physical quantity sensor 1 according to the first embodiment except that the shape of a protrusion 32 is different from that in the first embodiment. In the following descriptions, the physical quantity sensor 1 in the third embodiment will be described focusing on a difference from the above-described first embodiment, and descriptions of the similar items will not be repeated. In FIG. 12, the same components as those in the above-described first embodiment are denoted by the same reference signs.

As illustrated in FIG. 12, the protrusion 32 in this embodiment has a groove portion 323 at a tip surface 321 facing the substrate 2. In particular, in this embodiment, a plurality of groove portions 323 is formed in the tip surface 321. The plurality of groove portions 323 extends in the Y-axis direction (same direction) and is arranged at an equal pitch in the X-axis direction. Thus, for example, the contact area between the protrusion 32 and the substrate 2 is reduced in comparison to the above-described first embodiment. Therefore, it is possible to effectively reduce the occurrence of “sticking” which is a phenomenon in which the protrusion 32 sticks to the substrate 2 when the protrusion 32 and the substrate 2 are brought into contact with each other.

With such a third embodiment, it is also possible to exhibit effects similar to those in the above-described first embodiment. The configuration of the groove portion 323 is not limited to the configuration in this embodiment, and any configuration may be provided. For example, as illustrated in FIG. 13, the groove portion 323 may be formed at an outer circumference of the tip surface 321, so as to have a ring shape.

### Fourth Embodiment

Next, a physical quantity sensor according to a fourth embodiment will be described.

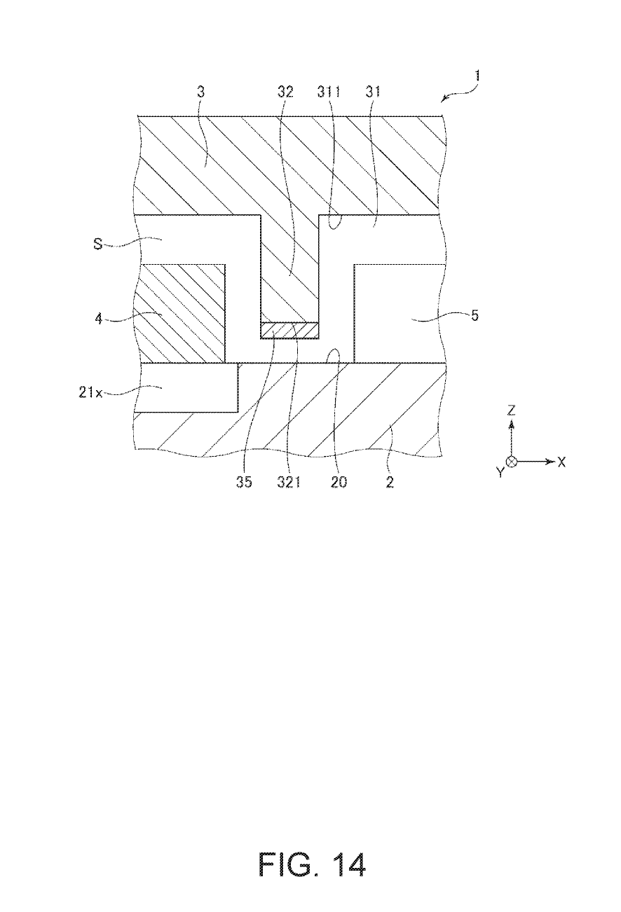

FIG. 14 is a sectional view illustrating a protrusion provided in the physical quantity sensor according to the fourth embodiment. FIG. 14 is a view corresponding to the sectional view taken along line A-A in FIG. 1, similar to FIG. 2.

A physical quantity sensor 1 in this embodiment is similar to the above-described physical quantity sensor 1 according to the first embodiment except that a functional film 35 is disposed on the tip surface 321 of the protrusion 32. In the following descriptions, the physical quantity sensor 1 in the fourth embodiment will be described focusing on a difference from the above-described first embodiment, and descriptions of the similar items will not be repeated. In FIG. 14, the same components as those in the above-described first embodiment are denoted by the same reference signs.

As illustrated in FIG. 14, in the physical quantity sensor 1 in this embodiment, the functional film 35 is provided on the tip surface 321 of the protrusion 32, which faces the substrate 2. In this embodiment, a film having water repellency is used as the functional film 35. In this case, the functional film 35 can be formed of diamond-like carbon (DLC), for example. As described above, if the functional film 35 having water repellency is disposed on the tip surface 321, for example, the protrusion 32 is easily separated from the substrate 2 in comparison to the above-described first embodiment. Thus, it is possible to effectively reduce the occurrence of sticking.

With such a fourth embodiment, it is also possible to exhibit effects similar to those in the above-described first embodiment. The function or the constituent material of the functional film 35 is not limited to that in this embodiment. For example, a configuration in which a film in which fine unevennesses are formed on the surface is used as the functional film 35, and thus the contact area between the protrusion 32 and the substrate 2 is reduced and the occurrence of sticking is reduced may be made. A configuration in which an insulating film is used as the functional film 35, and thus an insulating state between the lid 3 and the substrate 2 is maintained may be made.

### Fifth Embodiment

Next, a physical quantity sensor according to a fifth embodiment will be described.

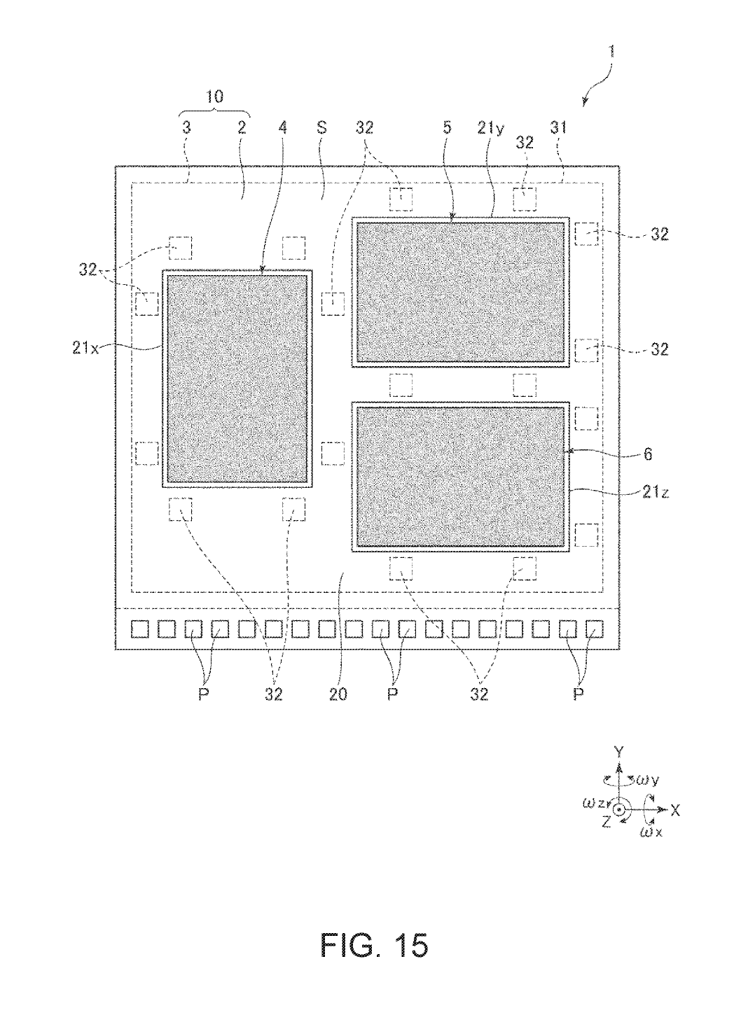

FIG. 15 is a plan view illustrating the physical quantity sensor according to the fifth embodiment.

A physical quantity sensor 1 in this embodiment is similar to the above-described physical quantity sensor 1 according to the first embodiment except that a plurality of protrusions 32 is arranged. In the following descriptions, the physical quantity sensor 1 in the fifth embodiment will be described focusing on a difference from the above-described first embodiment, and descriptions of the similar items will not be repeated. In FIG. 15, the same components as those in the above-described first embodiment are denoted by the same reference signs.

As illustrated in FIG. 15, in the physical quantity sensor 1 in this embodiment, the plurality of protrusions 32 is arranged in the lid 3. As described above, if the plurality of protrusions 32 is arranged in the lid 3, it is possible to more effectively reduce the downward bending deformation of the lid 3. Therefore, it is possible to more effectively reduce excessive deformation of the lid 3 and to more effectively reduce the damage of the lid 3. In addition, it is possible to more effectively reduce the occurrence of a situation in which the lid 3 is brought into contact with the sensor element 4, 5, or 6, and thus the sensor element 4, 5, or 6 is damaged. In particular, in this embodiment, the plurality of protrusions 32 is arranged to be dispersed in the entirety of the storage space S. Therefore, it is possible to more reliably reduce bending deformation of the lid 3 even though stress is applied to any portion of the lid 3. In this embodiment, the plurality of protrusions 32 is arranged to surround each of the sensor elements 4, 5, and 6. However, the arrangement of the plurality of protrusions 32 is not particularly limited.

With such a fifth embodiment, it is also possible to exhibit effects similar to those in the above-described first embodiment. The number or the arrangement of the protrusions 32 is not limited to that in this embodiment.

### Sixth Embodiment

Next, a physical quantity sensor according to a sixth embodiment will be described.

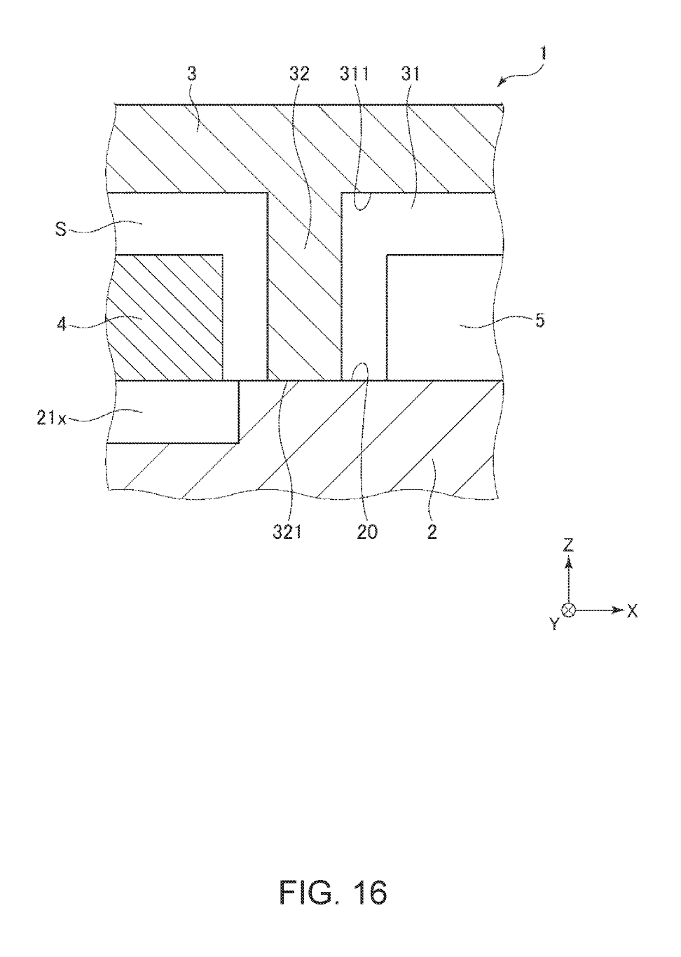

FIG. 16 is a sectional view illustrating a protrusion provided in the physical quantity sensor according to the sixth embodiment. FIG. 16 is a view corresponding to the sectional view taken along line A-A in FIG. 1, similar to FIG. 2.

A physical quantity sensor 1 in this embodiment is similar to the above-described physical quantity sensor 1 according to the first embodiment except that a protrusion 32 is in contact with the substrate 2. In the following descriptions, the physical quantity sensor 1 in the sixth embodiment will be described focusing on a difference from the above-described first embodiment, and descriptions of the similar items will not be repeated. In FIG. 16, the same components as those in the above-described first embodiment are denoted by the same reference signs.

As illustrated in FIG. 16, the protrusion 32 in this embodiment has a tip surface 321 which is in contact with the upper surface 20 of the substrate 2. However, the tip surface 321 is not bonded (adhered and fixed) to the upper surface 20 of the substrate 2. That is, the protrusion 32 is not bonded to the substrate 2 (upper surface 20), but is in contact with the substrate 2 so as to be separable from the substrate 2. Therefore, the protrusion 32 may be separated from the substrate 2 or may slide on the substrate 2, by stress applied to the lid 3. With such a configuration, it is also possible to effectively reduce downward bending deformation of the lid 3. Therefore, it is possible to reduce an occurrence of excessive deformation of the lid 3 and to effectively reduce the damage of the lid 3. In addition, it is possible to effectively reduce the occurrence of a situation in which the lid 3 is brought into contact with the sensor element 4, 5, or 6, and thus the sensor element 4, 5, or 6 is damaged.

In this embodiment, the protrusion 32 is just in contact with the substrate 2, not bonded to the substrate 2. Thus, the area in which the substrate 2 and the lid 3 are bonded to each other does not increase. Therefore, it is possible to suppress thermal stress occurring in the package 10 due to a difference of a thermal expansion coefficient between the substrate 2 and the lid 3, small. Thus, it is possible to effectively reduce the increase of thermal stress to be transferred to the sensor element 4, 5, or 6 and to effectively reduce deterioration of the angular-rate detection characteristics (particularly, temperature characteristics) of the sensor elements 4, 5, and 6.

With such a sixth embodiment, it is also possible to exhibit effects similar to those in the above-described first embodiment.

### Seventh Embodiment

Next, a physical quantity sensor according to a seventh embodiment will be described.

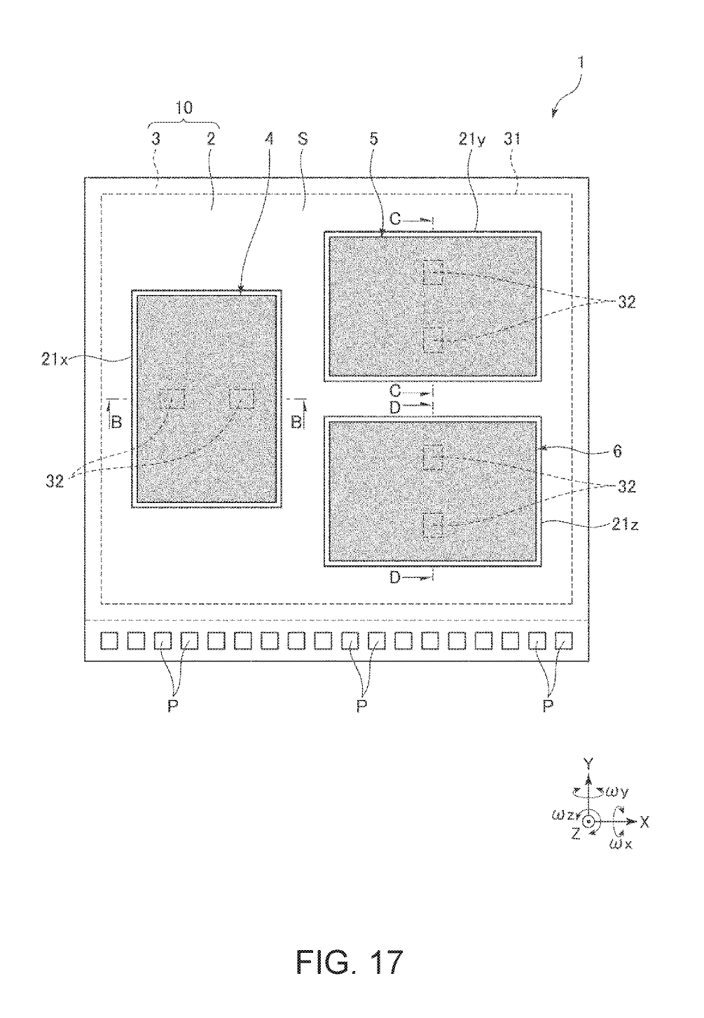

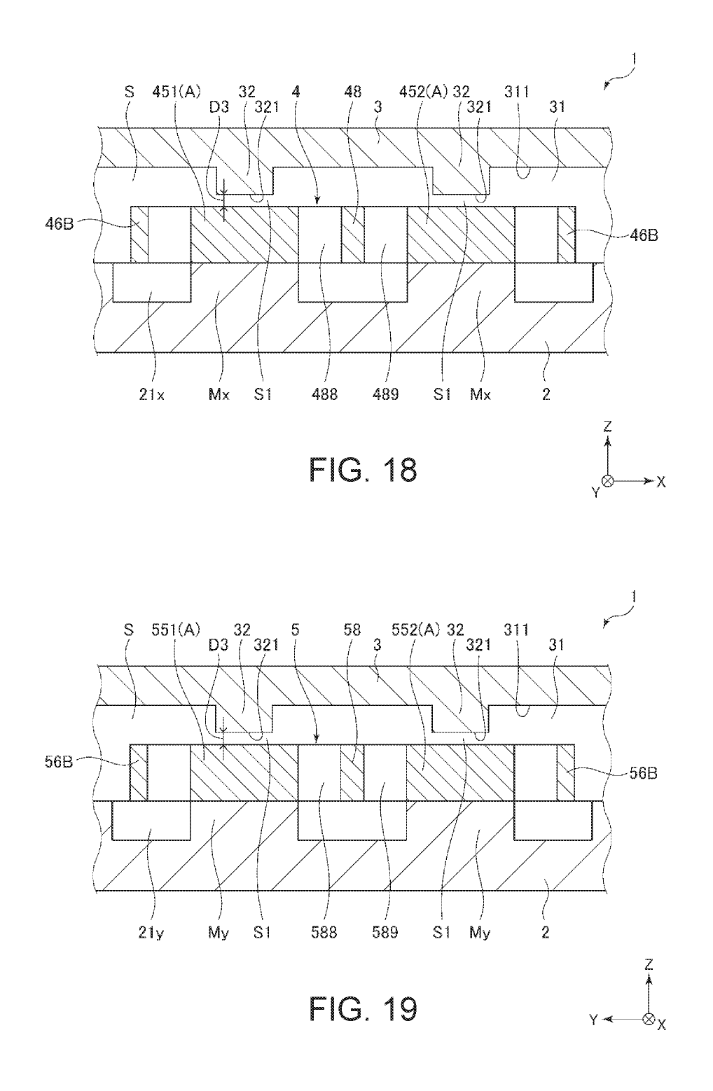

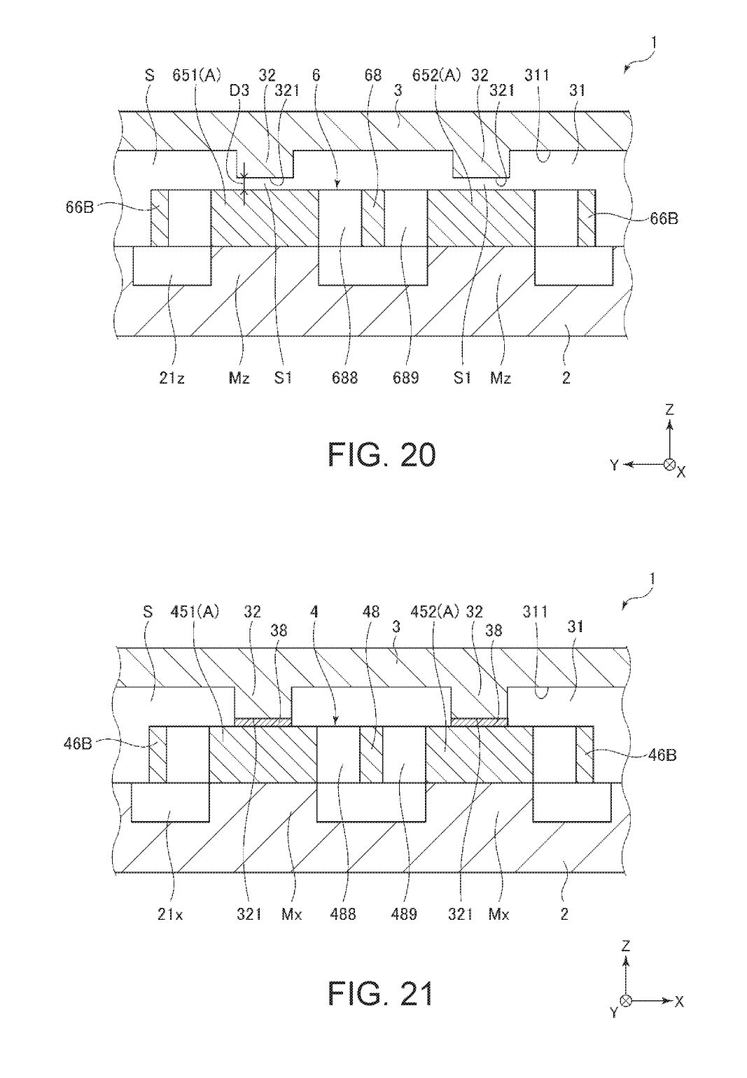

FIG. 17 is a plan view illustrating the physical quantity sensor according to the seventh embodiment. FIG. 18 is a sectional view taken along line B-B in FIG. 17. FIG. 19 is a sectional view taken along line C-C in FIG. 17. FIG. 20 is a sectional view taken along line D-D in FIG. 17.

A physical quantity sensor 1 in this embodiment is similar to the above-described physical quantity sensor according to the first embodiment except that the arrangement of protrusions 32 is different from that in the first embodiment. In the following descriptions, the physical quantity sensor 1 in the seventh embodiment will be described focusing on a difference from the above-described first embodiment, and descriptions of the similar items will not be repeated. In FIGS. 17 to 20, the same components as those in the above-described first embodiment are denoted by the same reference signs.

As illustrated in FIG. 17, in the physical quantity sensor 1 in this embodiment, a plurality of protrusions 32 is arranged to overlap the sensor elements 4, 5, and 6 in plan view in the Z-axis direction. Further, as illustrated in FIGS. 18 to 20, the protrusion 32 is disposed to overlap a fixation portion A which is a portion of each of the sensor elements 4, 5, and 6 fixed (bonded) to the substrate 2. The tip surface 321 of the protrusion is separated from the upper surface of the fixation portion A, and the gap S1 is formed between the tip surface 321 and the upper surface of the fixation portion A. In such a configuration, if the lid 3 deforms to be bent downward, the tip surface 321 of the protrusion 32 is brought into contact with the upper surface of the fixation portion A, and thus bending deformation of the lid 3 occurs no more.

Here, the fixation portion A refers to a portion of, for example, the sensor element 4, which is bonded to the upper surface of a mount Mx protruding from the recess portion 21x. That is, in a case of the sensor element 4, the fixation portion A refers to the base portion of the fixation portion 42A or 42B, the fixation portion 451 or 452, and the fixed driving electrode 412A or 412B, or the base portion of the fixed monitoring electrode 492A, 493A, 492B, or 493B. In a case of the sensor element 5, the fixation portion A refers to a portion of the sensor element, which is bonded to the upper surface of a mount My protruding from the recess portion 21y. That is, in a case of the sensor element 5, the fixation portion A refers to the base portion of the fixation portion 52A or 52B, the fixation portion 551 or 552, or the fixed driving electrode 512A or 512B, or the base portion of the fixed monitoring electrode 592A, 593A, 592B, or 593B. In a case of the sensor element 6, the fixation portion A refers to a portion of the sensor element, which is bonded to the upper surface of a mount Mz protruding from the recess portion 21z. That is, in a case of the sensor element 6, the fixation portion A refers to the base portion of the fixation portion 62A or 62B, the fixation portion 651 or 652, or the fixed driving electrode 612A or 612B, the base portion of the fixed detection electrode 642A, 643A, 642B, or 643B, or the base portion of the fixed monitoring electrode 692A, 693A, 692B, or 693B. The fixation portion A is supported from the lower part by the mount. Thus, if the lid 3 deforms to be bent and thus the protrusion 32 is brought into contact with the fixation portion A, bending deformation of the lid 3 occurs no more.

In this embodiment, the protrusions 32 are arranged to overlap the fixation portions 451 and 452 of the sensor element 4, as illustrated in FIG. 18. The protrusions 32 are arranged to overlap the fixation portions 551 and 552 of the sensor element 5, as illustrated in FIG. 19. In addition, the protrusions 32 are arranged to overlap the fixation portions 651 and 652 of the sensor element 6, as illustrated in FIG. 20. The number or the arrangement of the protrusions 32 is not particularly limited, and the protrusions 32 may be arranged to overlap other fixation portions A.

A distance D3 between the tip surface 321 of the protrusion 32 and the upper surface of the fixation portion A is not particularly limited. For example, the distance D3 is preferably from 5 μm to 40 μm, and more preferably from 10 μm to 20 μm. Thus, it is possible to cause the tip surface 321 and the fixation portion A to be sufficiently separated from each other, and it is possible to effectively reduce an unintentional contact (unintentionally electrical connection between the sensor element 4, 5, or 6 and the lid 3). Therefore, it is possible to effectively reduce variation in driving characteristics of the sensor element 4, 5, or 6. It is possible to sufficiently suppress the degree of bending deformation of the lid 3 small and to more effectively reduce the damage of the lid 3.

An insulating film is preferably disposed on at least one of the tip surface 321 of the protrusion 32 and the upper surface of the fixation portion A such that an electrical connection between the sensor element 4, 5, or 6 and the lid 3 does not occur when the lid 3 deforms to be bent and thus the protrusion 32 is brought into contact with the fixation portion A.

As described above, the physical quantity sensor 1 in this embodiment includes the substrate 2, the sensor elements 4, 5, and 6 including the fixation portion A fixed to the substrate 2, and the lid 3 bonded to the substrate 2 so as to store the sensor elements 4, 5, and 6 between the substrate 2 and the lid 3. The lid 3 includes the protrusion 32 on the substrate 2 side. The protrusion 32 is disposed to overlap the fixation portion A in plan view, and is separated from the fixation portion A. Thus, for example, even though the lid 3 deforms to be bent toward the substrate 2, the protrusion 32 abuts on (is brought into contact with) the substrate 2 at the initial state of the deformation, and thus the downward bending deformation of the lid 3 occurs no more. Therefore, it is possible to reduce an occurrence of excessive deformation of the lid 3 and to effectively reduce the damage of the lid 3.

With such a seventh embodiment, it is also possible to exhibit effects similar to those in the above-described first embodiment.

### Eighth Embodiment

Next, a physical quantity sensor according to an eighth embodiment will be described.

FIG. 21 is a sectional view illustrating a protrusion provided in the physical quantity sensor according to the eighth embodiment. FIG. 21 is a view corresponding to the sectional view taken along line B-B in FIG. 17, similar to FIG. 18.

A physical quantity sensor 1 in this embodiment is similar to the above-described physical quantity sensor according to the seventh embodiment except that a protrusion 32 is in contact with a fixation portion A. In the following descriptions, the physical quantity sensor 1 in the eighth embodiment will be described focusing on a difference from the above-described seventh embodiment, and descriptions of the similar items will not be repeated. In FIG. 21, the same components as those in the above-described seventh embodiment are denoted by the same reference signs.

As illustrated in FIG. 21, the protrusion 32 in this embodiment has a tip surface 321 which is in contact with the upper surface of the fixation portion A. However, the tip surface 321 is not bonded (adhered and fixed) to the upper surface of the fixation portion A. That is, the protrusion 32 is not bonded to the fixation portion A, but is in contact with the fixation portion A so as to be separable from the fixation portion A. Therefore, the protrusion 32 may be separated from the fixation portion A or may slide on the fixation portion A, by stress applied to the lid 3. With such a configuration, it is also possible to effectively reduce downward bending deformation of the lid 3. Therefore, it is possible to reduce an occurrence of excessive deformation of the lid 3 and to effectively reduce the damage of the lid 3. For easy descriptions, FIG. 21 illustrates the fixation portion A of the sensor element 4. However, the protrusion 32 is similarly in contact with the fixation portion A in a case of the sensor elements 5 and 6.

In this embodiment, an insulating film 38 is disposed between the fixation portion A and the protrusion 32 in order to prevent an electrical connection between the sensor element 4, 5, or 6 and the lid 3. That is, in this embodiment, the protrusion 32 is indirectly in contact with the fixation portion A with the insulating film 38 interposed between the protrusion 32 and the fixation portion A. The insulating film 38 may be omitted and thus the protrusion 32 may be directly in contact with the fixation portion A. The insulating film 38 may be disposed on the tip surface 321 of the protrusion 32 or on the upper surface of the fixation portion A, or may be disposed on both the tip surface 321 of the protrusion 32 and the upper surface of the fixation portion A.

With such an eighth embodiment, it is also possible to exhibit effects similar to those in the above-described seventh embodiment. In this embodiment, all the protrusions 32 are in contact with fixation portions A. However, it is not limited thereto, and some protrusions 32 may be separated from the fixation portions A as in the above-described seventh embodiment. That is, the protrusions 32 in contact with the fixation portions A and the protrusions 32 separated from the fixation portions A may be mixed.

### Ninth Embodiment

Next, a physical quantity sensor according to a ninth embodiment will be described.

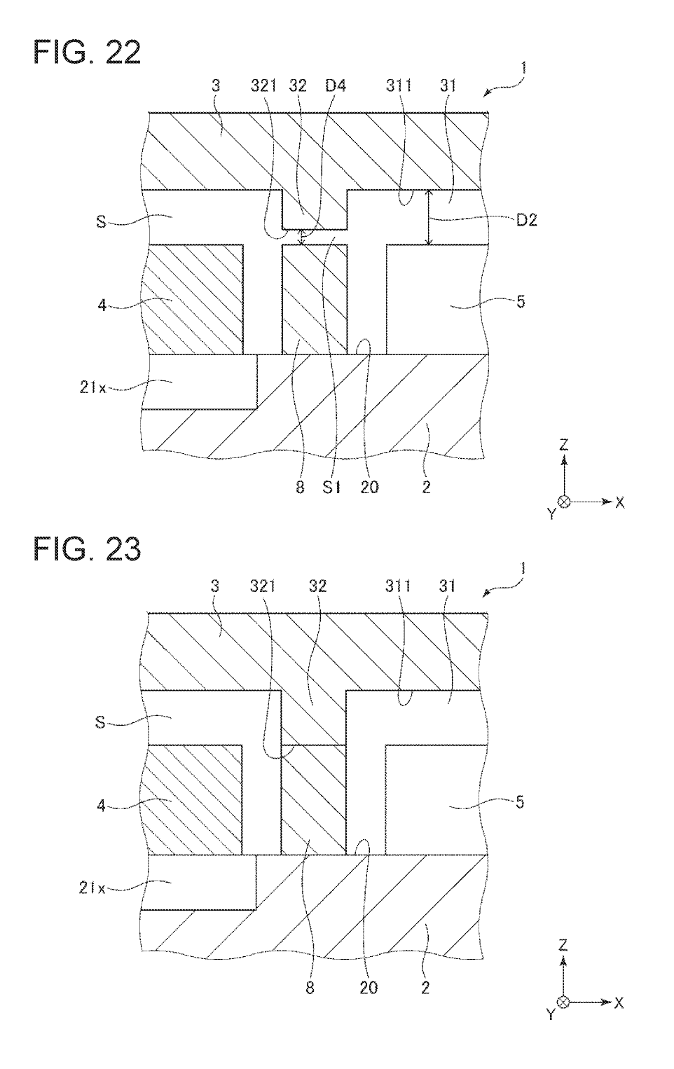

FIG. 22 is a sectional view illustrating a protrusion provided in the physical quantity sensor according to the ninth embodiment. FIG. 22 is a view corresponding to the sectional view taken along line A-A in FIG. 1, similar to FIG. 2.

A physical quantity sensor 1 in this embodiment is similar to the above-described physical quantity sensor 1 according to the first embodiment except that a structural member 8 is further provided, and the protrusion 32 is disposed to overlap the structural member 8. In the following descriptions, the physical quantity sensor 1 in the eighth embodiment will be described focusing on a difference from the above-described first embodiment, and descriptions of the similar items will not be repeated. In FIG. 22, the same components as those in the above-described first embodiment are denoted by the same reference signs.

As illustrated in FIG. 22, the physical quantity sensor 1 in this embodiment includes the structural member stored in the storage space S along with the sensor elements 4, 5, and 6. The structural member 8 is disposed not to overlap the sensor elements 4, 5, and 6 in plan view in the Z-axis direction and is bonded to the upper surface 20 of the substrate 2. Such a structural member 8 can be formed with a silicon substrate, integrally with the sensor elements 4, 5, and 6. The material or the method for forming the structural member 8 is not particularly limited.

The protrusion 32 is disposed to overlap the structural member 8 in plan view in the Z-axis direction. The tip surface 321 of the protrusion 32 is separated from the upper surface of the structural member 8, and the gap S1 is formed between the tip surface 321 and the upper surface of the structural member 8. In such a configuration, if the lid 3 deforms to be bent downward, the tip surface 321 of the protrusion 32 is brought into contact with the upper surface of the structural member 8, and thus downward bending deformation of the lid 3 occurs no more. Therefore, it is possible to reduce an occurrence of excessive deformation of the lid 3 and to effectively reduce the damage of the lid 3. In addition, it is possible to reduce an occurrence of a situation in which the lid 3 is brought into contact with the sensor element 4, 5, or 6, and thus the lid 3, or the sensor element 4, 5, or 6 is damaged.

A distance D4 between the tip surface 321 of the protrusion 32 and the upper surface of the structural member 8 is smaller than the distance D2 between the upper surface of the sensor element 4, 5, or 6 and the bottom surface 311 of the recess portion 31. Thus, if the lid 3 deforms to be bent downward, the tip surface 321 of the protrusion 32 abuts on the upper surface of the structural member 8 before the bottom surface 311 is brought into contact with the sensor element 4, 5, or 6, and thus the downward bending deformation of the lid 3 occurs no more. Therefore, it is possible to more reliably reduce an occurrence of a contact of the lid 3 with the sensor elements 4, 5, and 6. The distance D4 is not particularly limited. For example, the distance D4 is preferably from 5 μm to 40 μm, and more preferably from 10 μm to 20 μm. Thus, it is possible to cause the protrusion 32 and the structural member 8 to be sufficiently separated from each other, and to sufficiently suppress the degree of bending deformation of the lid 3 small. Therefore, it is possible to more effectively reduce the damage of the lid 3 or the sensor elements 4, 5, and 6.

As described above, the physical quantity sensor 1 in this embodiment includes the substrate 2, the sensor elements 4, 5, and 6 supported on the substrate 2, the structural member 8 which is supported on the substrate 2 and is disposed not to overlap the sensor elements 4, 5, and 6 in plan view, and the lid 3 bonded to the substrate 2 so as to store the sensor elements 4, 5, and 6 and the structural member 8 between the lid 3 and the substrate 2. The lid 3 includes the protrusion 32 on the substrate 2 side. The protrusion 32 overlaps the structural member 8 in plan view and is separated from the structural member 8. Thus, for example, even though the lid 3 deforms to be bent toward the substrate 2, the protrusion 32 abuts on (is brought into contact with) the structural member 8 at the initial state of the deformation, and thus the downward bending deformation of the lid 3 occurs no more. Therefore, it is possible to reduce an occurrence of excessive deformation of the lid 3 and to effectively reduce the damage of the lid 3. In addition, it is possible to reduce an occurrence of a situation in which the lid 3 is brought into contact with the sensor element 4, 5, or 6, and thus the lid 3, or the sensor element 4, 5, or 6 is damaged.

With such a ninth embodiment, it is also possible to exhibit effects similar to those in the above-described first embodiment.

### Tenth Embodiment

Next, a physical quantity sensor according to a tenth embodiment will be described.

FIG. 23 is a sectional view illustrating a protrusion provided in the physical quantity sensor according to the tenth embodiment. FIG. 23 is a view corresponding to the sectional view taken along line A-A in FIG. 1, similar to FIG. 2.

A physical quantity sensor 1 in this embodiment is similar to the above-described physical quantity sensor 1 according to the ninth embodiment except that a protrusion is in contact with the structural member 8. In the following descriptions, the physical quantity sensor 1 in the tenth embodiment will be described focusing on a difference from the above-described ninth embodiment, and descriptions of the similar items will not be repeated. In FIG. 23, the same components as those in the above-described ninth embodiment are denoted by the same reference signs.

As illustrated in FIG. 23, the protrusion 32 in this embodiment has a tip surface 321 which is in contact with the upper surface of the structural member 8. However, the tip surface 321 is not bonded (adhered and fixed) to the upper surface of the structural member 8. That is, the protrusion 32 is not bonded to the structural member 8, but is in contact with the structural member 8 so as to be separable from the structural member 8. Therefore, the protrusion 32 may be separated from the structural member 8 or may slide on the structural member 8, by stress applied to the lid 3. With such a configuration, it is also possible to effectively reduce downward bending deformation of the lid 3. Therefore, it is possible to reduce an occurrence of excessive deformation of the lid 3 and to effectively reduce the damage of the lid 3.

With such a tenth embodiment, it is also possible to exhibit effects similar to those in the above-described ninth embodiment.

### Eleventh Embodiment

Next, a physical quantity sensor according to an eleventh embodiment will be described.

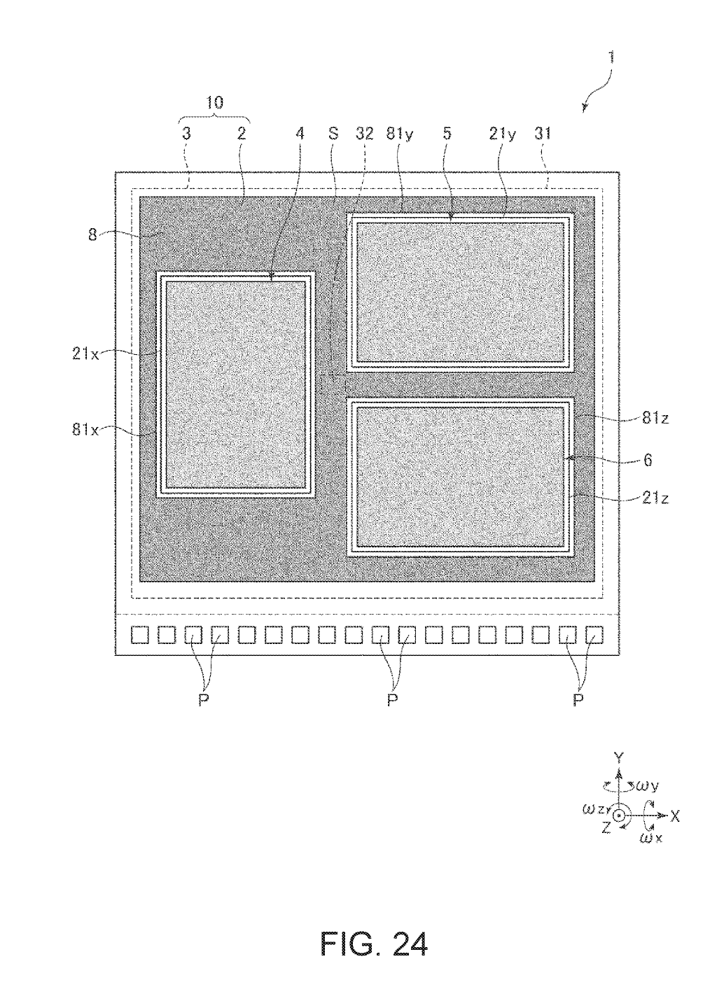

FIG. 24 is a plan view illustrating the physical quantity sensor according to the eleventh embodiment.

A physical quantity sensor 1 in this embodiment is similar to the above-described physical quantity sensor according to the ninth embodiment except that a configuration of the structural member 8 is different from that in the ninth embodiment. In the following descriptions, the physical quantity sensor 1 in the eleventh embodiment will be described focusing on a difference from the above-described ninth embodiment, and descriptions of the similar items will not be repeated. In FIG. 24, the same components as those in the above-described ninth embodiment are denoted by the same reference signs.

In the physical quantity sensor 1 in this embodiment, the structural member 8 is disposed to surround each of the sensor elements 4, 5, and 6 in plan view. Specifically, as illustrated in FIG. 24, the structural member 8 includes three openings 81x, 81y, and 81z. The sensor element 4 is disposed in the opening 81x, the sensor element 5 is disposed in the opening 81y, and the sensor element 6 is disposed in the opening 81z. Such a structural member 8 functions as, for example, a shield electrode which is connected to the ground (fixed potential) and blocks infiltration of disturbance into the sensor element 4, 5, or 6. Therefore, it is possible to improve detection accuracy of the angular rate of the physical quantity sensor 1. The structural member 8 is not particularly limited. For example, the structural member 8 may be disposed to surround at least a portion of at least one of the sensor elements 4, 5, and 6.

With such an eleventh embodiment, it is also possible to exhibit effects similar to those in the above-described ninth embodiment.

### Twelfth Embodiment

Next, a physical quantity sensor device according to a twelfth embodiment will be described.

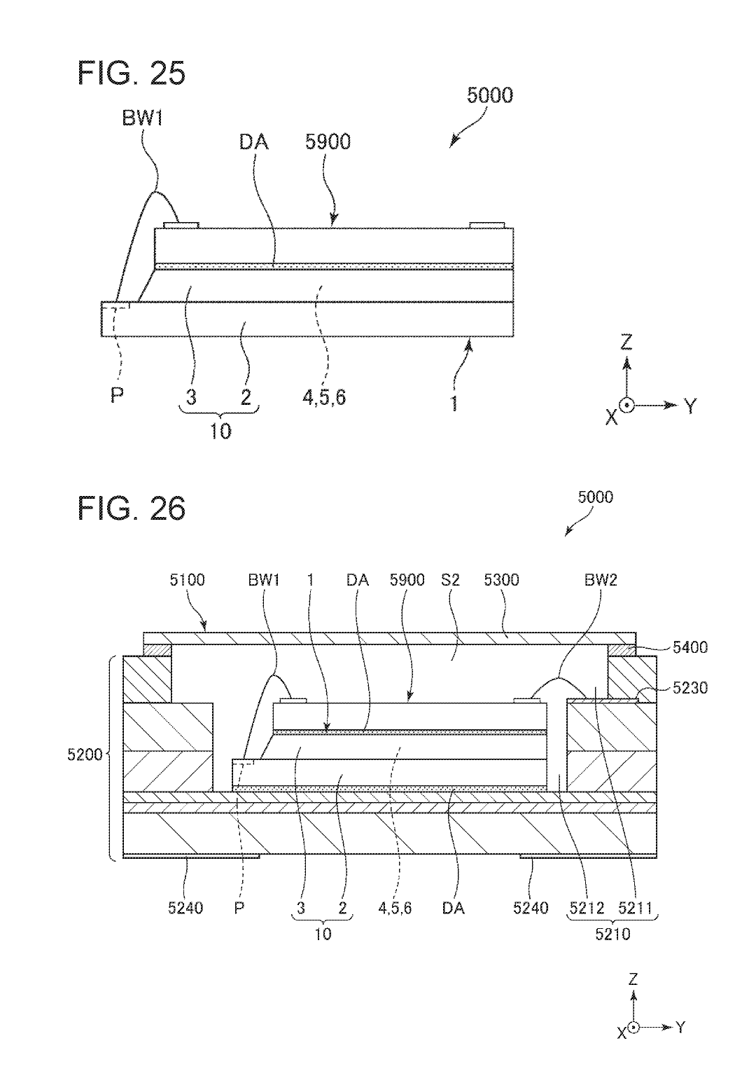

FIG. 25 is a sectional view illustrating the physical quantity sensor device according to the twelfth embodiment.

As illustrated in FIG. 25, a physical quantity sensor device 5000 includes a physical quantity sensor 1 and a semiconductor element (circuit element) 5900. For example, the physical quantity sensor in any of the above-described embodiments can be used as the physical quantity sensor 1.

The semiconductor element 5900 is bonded to the upper surface of the lid 3 with a die-attach material (bonding member) DA. The semiconductor element 5900 is electrically connected to the connection pad P of the physical quantity sensor 1 via a bonding wiring BW1. If necessary, the semiconductor element 5900 includes, for example, a driving circuit that applies a driving voltage to the sensor elements 4, 5, and 6, a detection circuit that detects the angular rates ωx, ωy, and ωz based on outputs from the sensor elements 4, 5, and 6, or an output circuit that converts a signal from the detection circuit into a predetermined signal and outputs the predetermined signal.

Here, in a step of bonding the semiconductor element 5900 to the upper surface of the lid 3, the semiconductor element 5900 is pressed on the lid 3 in order to more reliably perform bonding. The lid 3 deforms to be bent toward the substrate 2, by stress applied at this time. However, as described above, since the protrusion 32 is provided in the lid 3, the degree of bending deformation of the lid 3 is reduced by the protrusion 32. Therefore, it is possible to effectively reduce the damage of the lid 3 occurring by stress applied at time of bonding the semiconductor element 5900.

Hitherto, the physical quantity sensor device 5000 is described. Such a physical quantity sensor device 5000 includes the physical quantity sensor 1 and the semiconductor element (circuit element) 5900. Therefore, a physical quantity sensor device 5000 which is capable of exhibiting the effect of the physical quantity sensor 1 and has high reliability is obtained.

### Thirteenth Embodiment

Next, a physical quantity sensor device according to a thirteenth embodiment will be described.

FIG. 26 is a sectional view illustrating the physical quantity sensor device according to the thirteenth embodiment.

A physical quantity sensor device 5000 in this embodiment is similar to the above-described physical quantity sensor device 5000 according to the twelfth embodiment except that a package 5100 is further provided. In the following descriptions, the physical quantity sensor device 5000 in the thirteenth embodiment will be described focusing on a difference from the above-described twelfth embodiment, and descriptions of the similar items will not be repeated. In FIG. 26, the same components as those in the above-described twelfth embodiment are denoted by the same reference signs.

As illustrated in FIG. 26, the physical quantity sensor device 5000 includes a package 5100 that stores a physical quantity sensor 1 and a semiconductor element (circuit element) 5900. Therefore, it is possible to properly protect the physical quantity sensor 1 and the semiconductor element 5900 from an impact, dust, heat, moisture, and the like, by the package 5100.

The package 5100 includes a cavity-like base (substrate) 5200 and a lid 5300 bonded to the upper surface of the base 5200. The base 5200 includes a recess portion 5210 which opens to the upper surface thereof. The recess portion 5210 includes a first recess portion 5211 which opens to the upper surface of the base 5200 and a second recess portion 5212 which opens to the bottom surface of the first recess portion 5211.

The lid 5300 has a plate shape and is bonded to the upper surface of the base 5200 so as to close the opening of the recess portion 5210. A storage space S2 is formed in the package 5100 by the lid 5300 closing the opening of the recess portion 5210 in this manner, and thus the physical quantity sensor 1 and the semiconductor element 5900 are stored in the storage space S2. A method of bonding the base 5200 and the lid 5300 to each other is not particularly limited. In this embodiment, seam welding using a seam ring 5400 is used.

The storage space S2 is airtightly sealed. The atmosphere of the storage space S2 is not particularly limited. For example, the atmosphere of the storage space S2 is preferably set to be the same as the atmosphere of the storage space S of the physical quantity sensor 1. Thus, it is possible to maintain the atmosphere of the storage space S as it is, even if airtightness of the storage space S collapses, and the storage spaces S and S2 communicate with each other. Therefore, it is possible to reduce variation in detection characteristics of the physical quantity sensor 1 occurring by changing the atmosphere of the storage space S, and to exhibit the stable detection characteristics.

A material for forming the base 5200 is not particularly limited. For example, various ceramics such as alumina, zirconia, and titania can be used. A material for forming the lid 5300 is not particularly limited. For example, a material having a linear expansion coefficient which is approximate to that of the material for forming the base 5200 may be provided. For example, in a case where the above-described ceramic is provided as the material for forming the base 5200, alloys with cobalt and the like are preferably used.

The base 5200 includes a plurality of internal terminals 5230 arranged in the storage space S2 (on the bottom surface of the first recess portion 5211) and a plurality of external terminals 5240 arranged on the bottom surface of the base. Each of the internal terminals 5230 is electrically connected to the predetermined external terminal 5240 via an internal interconnection (not illustrated) disposed in the base 5200.

The physical quantity sensor 1 is fixed to the bottom surface of the recess portion 5210 via a die-attach material DA. In addition, the semiconductor element 5900 is disposed on the upper surface of the physical quantity sensor 1 with a die-attach material DA interposed between the semiconductor element 5900 and the upper surface of the physical quantity sensor 1. Thus, the physical quantity sensor 1 and the semiconductor element 5900 are electrically connected to each other via the bonding wiring BW1, and the semiconductor element 5900 and the internal terminal 5230 are electrically connected to each other via a bonding wiring BW2.

### Fourteenth Embodiment

Next, a physical quantity sensor device according to a fourteenth embodiment will be described.

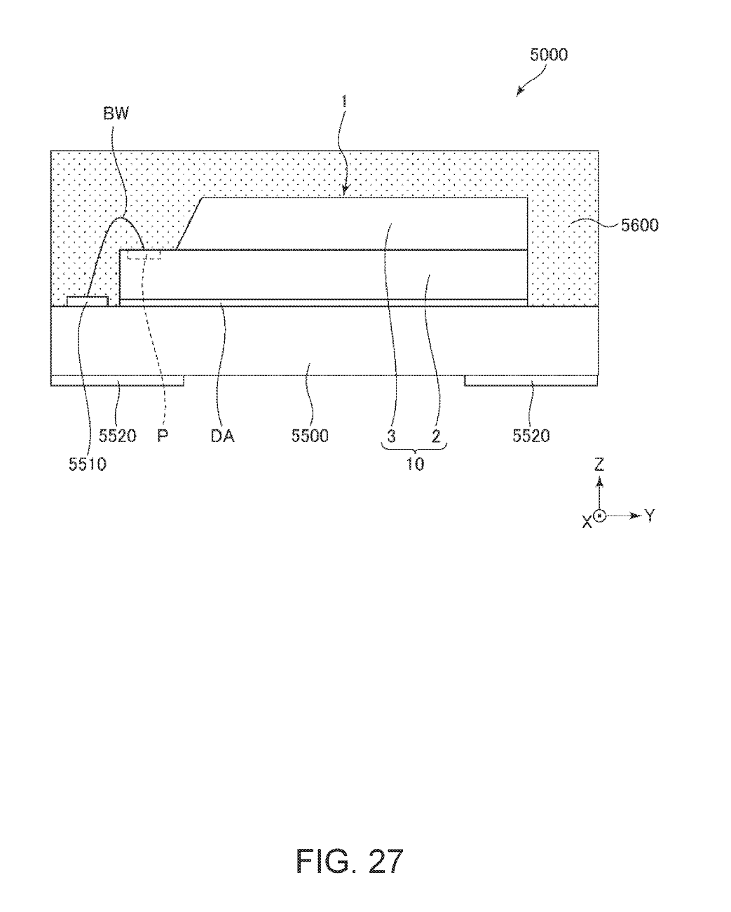

FIG. 27 is a sectional view illustrating the physical quantity sensor device according to the fourteenth embodiment.

As illustrated in FIG. 27, a physical quantity sensor device 5000 includes a base substrate 5500, a physical quantity sensor 1 provided on the base substrate 5500, a bonding wiring BW that electrically connects the physical quantity sensor 1 and the base substrate 5500, and a resin package 5600 that covers the physical quantity sensor 1. Here, the physical quantity sensor in any of the above-described embodiments can be used as the physical quantity sensor 1.

The base substrate 5500 is a substrate that supports the physical quantity sensor 1, and is an interposer substrate, for example. A plurality of connection terminals 5510 is arranged on the upper surface of such a base substrate 5500, and a plurality of mounting terminals 5520 is arranged on the lower surface of the base substrate. Internal interconnections (not illustrated) are arranged in the base substrate 5500. Thus, each of the connection terminals 5510 is electrically connected to the corresponding mounting terminal 5520 via the internal interconnection. The physical quantity sensor 1 is bonded to the upper surface of such a base substrate 5500 with a die-attach material (bonding member) DA. The connection terminal 5510 and the connection pad P are electrically connected to each other via the bonding wiring BW. The base substrate 5500 is not particularly limited. For example, a silicon substrate, a ceramic substrate, a resin substrate, a glass substrate, and a glass epoxy substrate can be used.

The resin package 5600 covers the physical quantity sensor 1. Thus, it is possible to protect the physical quantity sensor 1 from moisture, dust, an impact, and the like. The resin package 5600 is not particularly limited. For example, a thermosetting epoxy resin can be used. The resin package can be formed by a transfer molding method, for example. Here, resin is injected at high pressure when transfer molding is performed. Thus, the lid 3 deforms to be bent toward the substrate 2 by stress applied at this time. However, as described above, the protrusion 32 is provided in the lid 3, and thus the degree of bending deformation of the lid 3 is reduced by the protrusion 32. Therefore, it is possible to effectively reduce the damage of the lid 3 occurring by stress applied in transfer molding.

As described above, the physical quantity sensor device 5000 includes the physical quantity sensor 1 and the resin package 5600 that covers the physical quantity sensor 1. Therefore, a physical quantity sensor device 5000 which is capable of exhibiting the effect of the physical quantity sensor 1 and has high reliability is obtained. It is possible to properly protect the physical quantity sensor 1 from an impact, dust, heat, moisture, and the like, by the resin package 5600.

### Fifteenth Embodiment

Next, a complex sensor device according to a fifteenth embodiment will be described.

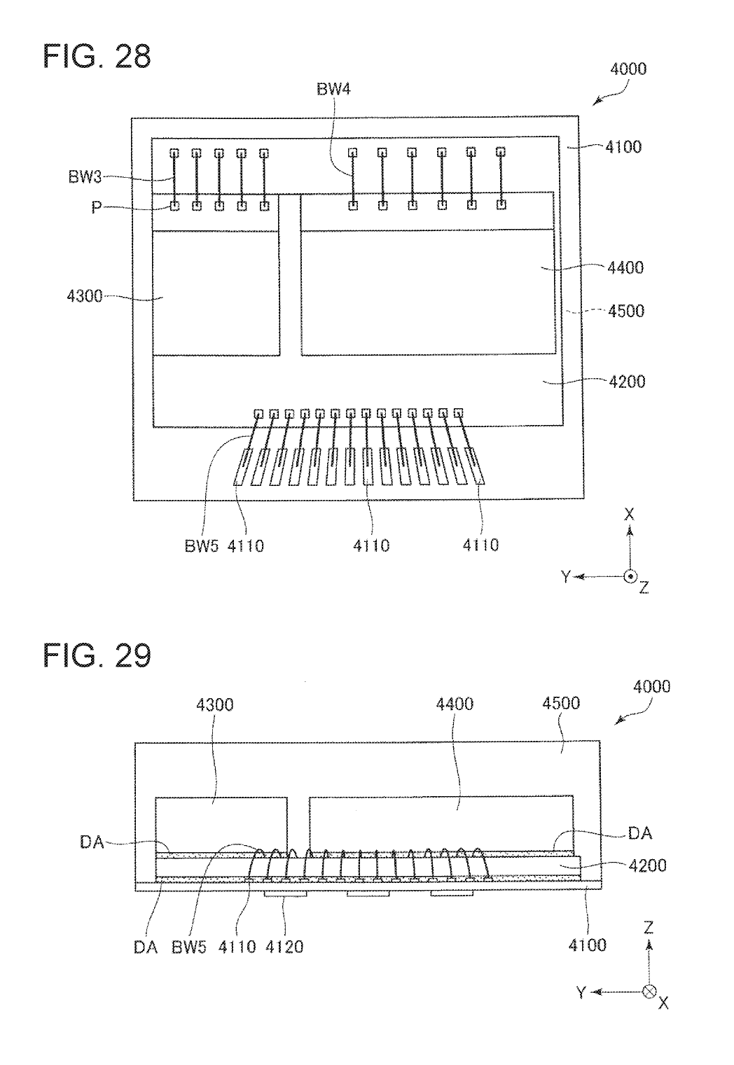

FIG. 28 is a plan view illustrating the complex sensor device according to the fifteenth embodiment. FIG. 29 is a sectional view illustrating the complex sensor device illustrated in FIG. 28.

As illustrated in FIGS. 28 and 29, a complex sensor device 4000 includes a base substrate 4100, a semiconductor element (circuit element) 4200, an acceleration sensor (second physical quantity sensor) 4300, an angular rate sensor (first physical quantity sensor) 4400, and a resin package 4500. The semiconductor element 4200 is mounted on the upper surface of the base substrate 4100 with a die-attach material (resin adhesive) DA. The acceleration sensor 4300 and the angular rate sensor 4400 are mounted on the upper surface of the semiconductor element 4200 with a die-attach material DA. The resin package 4500 covers the semiconductor element 4200, the acceleration sensor 4300, and the angular rate sensor 4400. The acceleration sensor 4300 is a three-axis acceleration sensor capable of independently detecting an acceleration of each of three axes (X axis, Y axis, and Z axis) which are orthogonal to each other. For example, a capacitive sensor can be used. The angular rate sensor 4400 is a three-axis angular rate sensor capable of independently detecting an angular rate of each of three axes (X axis, Y axis, and Z axis) which are orthogonal to each other. For example, the physical quantity sensor 1 in the above-described embodiments can be applied as the angular rate sensor.

The base substrate 4100 includes a plurality of connection terminals 4110 provided on the upper surface of the base substrate and a plurality of external terminals 4120 provided on the lower surface thereof. Each of the connection terminals 4110 is electrically connected to the corresponding external terminal 4120 via an internal interconnection (not illustrated) disposed in the base substrate 4100. The semiconductor element 4200 is disposed on the upper surface of such a base substrate 4100.

If necessary, the semiconductor element 4200 includes a driving circuit, an acceleration detection circuit, an angular-rate detection circuit, an output circuit, and the like. The driving circuit drives the acceleration sensor 4300 and the angular rate sensor 4400. The acceleration detection circuit independently detects each of an acceleration in the X-axis direction, an acceleration in the Y-axis direction, and an acceleration in the Z-axis direction based on an output from the acceleration sensor 4300. The angular-rate detection circuit independently detects each of an angular rate about the X axis, an angular rate about the Y axis, and an angular rate about the Z axis based on the output from the angular rate sensor 4400. The output circuit converts signals from the acceleration detection circuit and the angular-rate detection circuit into predetermined signals, and outputs the predetermined signals.

Such a semiconductor element 4200 is electrically connected to the acceleration sensor 4300 via a bonding wiring BW3, is electrically connected to the angular rate sensor 4400 via a bonding wiring BW4, and is electrically connected to the connection terminal 4110 of the base substrate 4100 via a bonding wiring BW5. The acceleration sensor 4300 and the angular rate sensor 4400 are disposed on the upper surface of such a semiconductor element 4200, in parallel.

Hitherto, the complex sensor device 4000 is described. As described above, such a complex sensor device 4000 includes the angular rate sensor (first physical quantity sensor) 4400 and the acceleration sensor (second physical quantity sensor) 4300 that detects a physical quantity different from that in the angular rate sensor 4400. Thus, a complex sensor device 4000 which is capable of detecting physical quantities having different types and has high convenience is obtained. In particular, in this embodiment, the first physical quantity sensor is the angular rate sensor 4400 capable of detecting an angular rate, and the second physical quantity sensor is the acceleration sensor 4300 capable of detecting the acceleration. Therefore, a complex sensor device 4000 which is capable of being suitably used as, for example, a motion sensor and has very high convenience is obtained.

The arrangement of the acceleration sensor 4300 and the angular rate sensor 4400 is not particularly limited. For example, the acceleration sensor 4300 and the angular rate sensor 4400 may be mounted on the upper surface of the base substrate 4100 so as to interpose the semiconductor element 4200 between the acceleration sensor 4300 and the angular rate sensor 4400. With such a configuration, it is possible to reduce the height of the complex sensor device 4000.

### Sixteenth Embodiment

Next, an inertial measurement unit according to a sixteenth embodiment will be described.

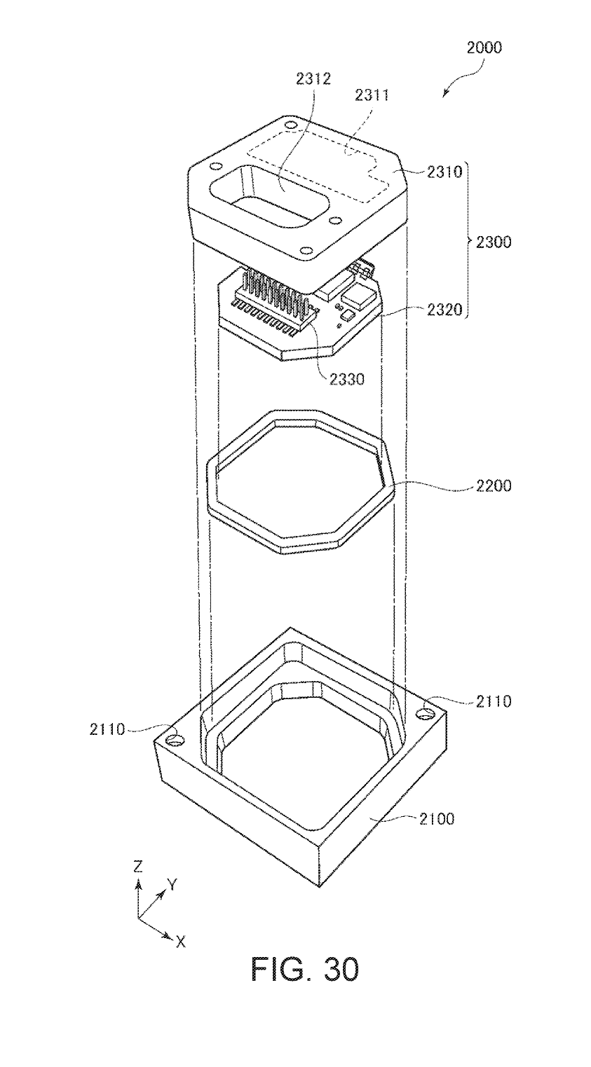

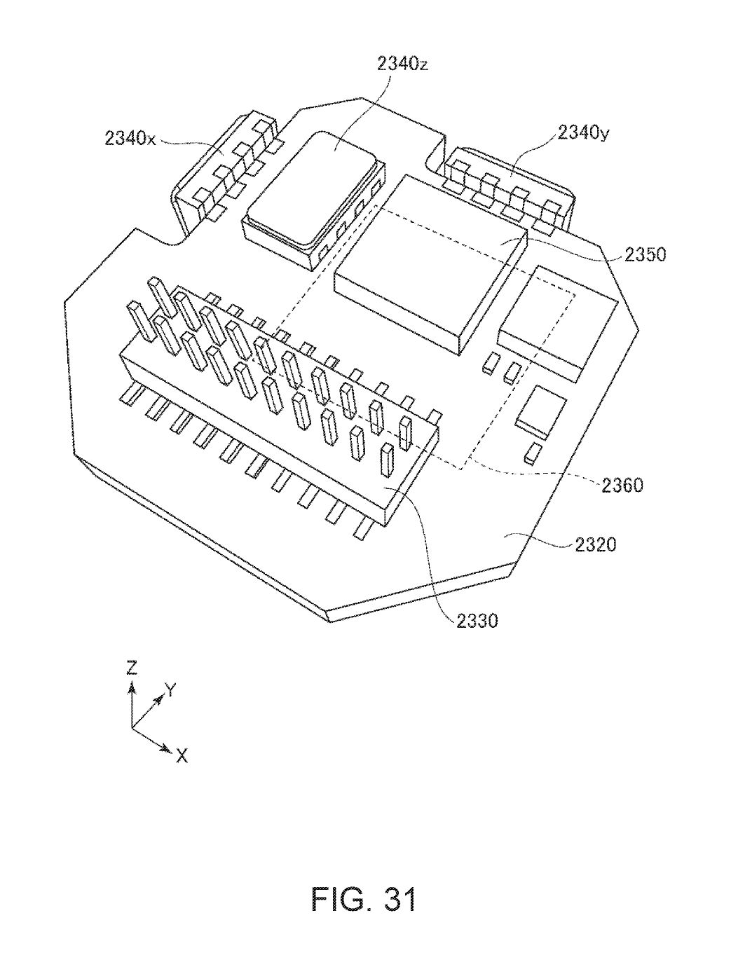

FIG. 30 is an exploded perspective view illustrating the inertial measurement unit according to the sixteenth embodiment. FIG. 31 is a perspective view illustrating a substrate provided in the inertial measurement unit illustrated in FIG. 30.

The inertial measurement unit (IMU) 2000 illustrated in FIG. 30 is an inertial measurement unit that detects an attitude or a movement (inertial momentum) of a vehicle (device in which the unit is mounted) such as an automobile or a robot. The inertial measurement unit 2000 functions as a so-called six-axis motion sensor which includes a three-axis acceleration sensor and a three-axis angular rate sensor.

The inertial measurement unit 2000 is a rectangular parallelepiped having a planar shape which is roughly square. Screw holes 2110 as the fixation portions are formed in the vicinity of two vertices positioned in a diagonal direction of the square. The inertial measurement unit 2000 can be fixed to a mounting target surface of a mounting target object such as an automobile by causing two screws to pass through the two screw holes 2110. The size thereof can be reduced to a size as small as can be mounted in, for example, a smartphone or a digital camera, by selecting components or changing a design.

The inertial measurement unit 2000 includes an outer case 2100, a bonding member 2200, and a sensor module 2300. The inertial measurement unit 2000 has a configuration in which the sensor module 2300 is inserted into the outer case 2100 with the bonding member 2200 interposed between the outer case 2100 and the sensor module 2300. The sensor module 2300 includes an inner case 2310 and a substrate 2320.

The appearance of the outer case 2100 is a rectangular parallelepiped having a planar shape which is roughly square, similar to the entire shape of the above-described inertial measurement unit 2000. The screws hole 2110 are formed in the vicinity of two vertices positioned in a diagonal direction of the square. The outer case 2100 has a box shape, and the sensor module 2300 is stored in the outer case 2100.

The inner case 2310 is a member that supports the substrate 2320 and has a shape that fits in the outer case 2100. A recess portion 2311 for preventing a contact with the substrate 2320 or an opening 2312 for exposing a connector 2330 (which will be described later) is formed in the inner case 2310. Such an inner case 2310 is bonded to the outer case 2100 with the bonding member 2200 (for example, packing in which an adhesive has been impregnated). The substrate 2320 is bonded to the lower surface of the inner case 2310 with an adhesive.

As illustrated in FIG. 31, the connector 2330, an angular rate sensor 2340z that detects an angular rate about the Z axis, an acceleration sensor 2350 that detects an acceleration in each axis direction of the X axis, the Y axis, and the Z axis, and the like are mounted on the upper surface of the substrate 2320. An angular rate sensor 2340x that detects an angular rate about the X axis and an angular rate sensor 2340y that detects an angular rate about the Y axis are mounted on the side surface of the substrate 2320. The physical quantity sensor 1 can be applied as the sensors 2340z, 2340x, 2340y, and 2350.

A control IC 2360 is mounted on the lower surface of the substrate 2320. The control IC 2360 is a micro-controller unit (MCU). The control IC includes a storage unit including a non-volatile memory, an A/D converter, and the like mounted therein, and controls the components of the inertial measurement unit 2000. The storage unit stores a program in which the procedure and the details for detecting an acceleration and an angular rate have been specified, a program of digitizing detection data and incorporating the data into packet data, accompanying data, and the like. In addition, a plurality of electronic components is mounted on the substrate 2320.

Hitherto, the inertial measurement unit 2000 is described. As described above, such an inertial measurement unit 2000 includes the angular rate sensors 2340z, 2340x, and 2340y, and the acceleration sensor 2350 as the physical quantity sensors and the control IC (control circuit) 2360 that controls driving of each of the sensors 2340z, 2340x, 2340y, and 2350. Thus, an inertial measurement unit 2000 which is capable of exhibiting the effect of the physical quantity sensor and has high reliability is obtained.

### Seventeenth Embodiment

Next, a vehicle positioning device according to a seventeenth embodiment will be described.

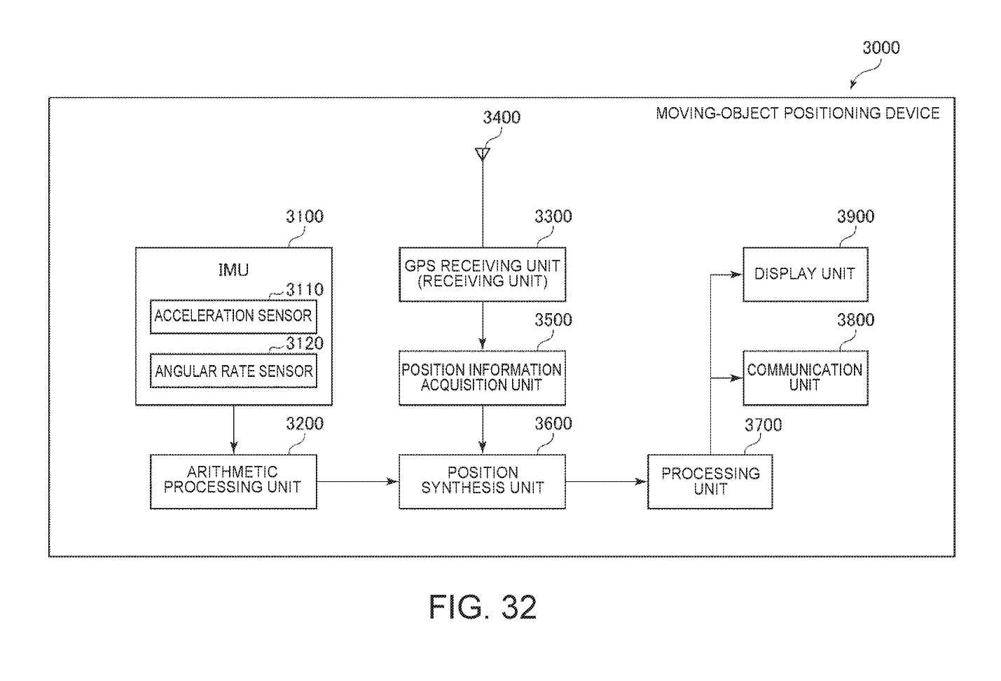

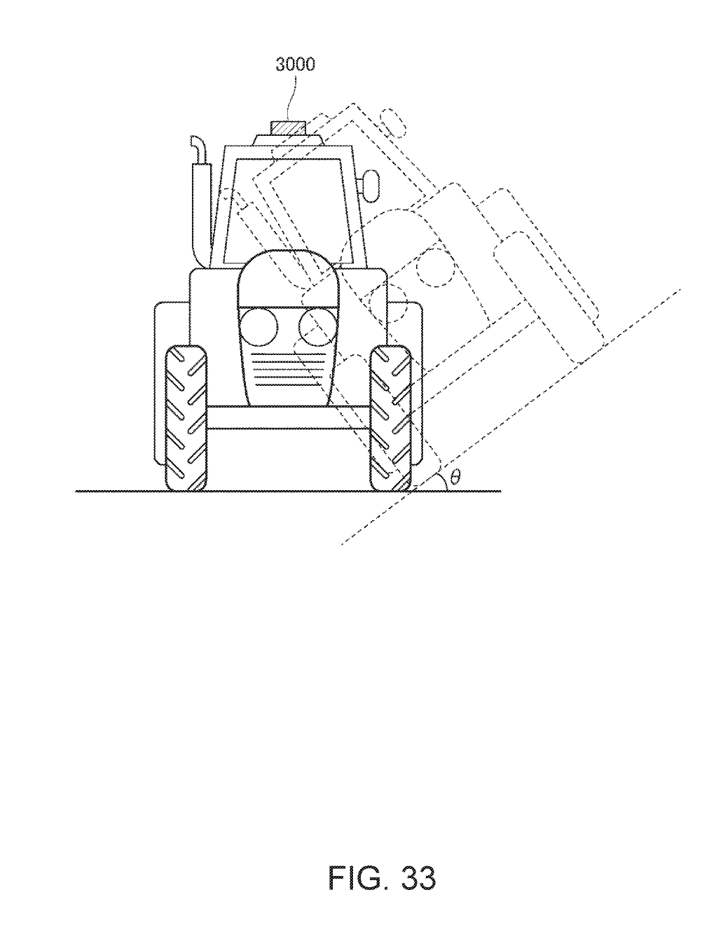

FIG. 32 is a block diagram illustrating the entire system of the vehicle positioning device according to the seventeenth embodiment. FIG. 33 is a diagram illustrating an action of the vehicle positioning device illustrated in FIG. 32.

The vehicle positioning device 3000 illustrated in FIG. 32 is a device which is used in a state of being mounted in a vehicle and is used for positioning the vehicle. The vehicle is not particularly limited. Any of bicycles, automobiles (including four-wheeled vehicles and bikes), trains, airplanes, ships, and the like may be provided. In this embodiment, descriptions will be made on the assumption that the vehicle is a four-wheeled vehicle. The vehicle positioning device 3000 includes an inertial measurement unit (IMU) 3100, an arithmetic processing unit (processor) 3200, a GPS receiving unit (receiver) 3300, a receiving antenna 3400, a position information acquisition unit 3500, a position synthesis unit (synthesizer) 3600, a processing unit (processor) 3700, a communication unit 3800, and a display unit 3900. For example, the above-described inertial measurement unit 2000 can be used as the inertial measurement unit 3100.

The inertial measurement unit 3100 includes a three-axis acceleration sensor 3110 and a three-axis angular rate sensor 3120. The arithmetic processing unit (processor) 3200 receives acceleration data from the acceleration sensor 3110 and angular rate data from the angular rate sensor 3120. The arithmetic processing unit (processor) 3200 performs inertial navigation arithmetic processing on the received data, and thus outputs inertial navigation positioning data (data including an acceleration and an attitude of the vehicle).

The GPS receiving unit (receiver) 3300 receives a signal (GPS carrier wave, satellite signal on which position information is superimposed) from a GPS satellite through the receiving antenna 3400. The position information acquisition unit 3500 outputs GPS positioning data indicating the position (latitude, longitude, and altitude), the speed, and the azimuth of the vehicle positioning device (vehicle) 3000, based on the signal received from the GPS receiving unit (receiver) 3300. The GPS positioning data also includes status data indicating a reception state, a reception time point, or the like.

The position synthesis unit (synthesizer) 3600 calculates the position of the vehicle, specifically, the position of the vehicle travelling on a map, based on inertial navigation positioning data output from the arithmetic processing unit (processor) 3200 and GPS positioning data output from the position information acquisition unit 3500. For example, if the attitude of the vehicle is different by an influence of the inclination of a map, as illustrated in FIG. 33, even though the position of the vehicle, which is included in the GPS positioning data is the same, the vehicle seems to travel at a different position on the map. Therefore, calculating the precise position of the vehicle only with GPS positioning data is not possible. The position synthesis unit (synthesizer) 3600 calculates the position of the vehicle travelling on the map, by using the inertial navigation positioning data (in particular, data regarding the attitude of the vehicle). The determination can be performed relatively easily by calculation using a trigonometric function (inclination θ with respect to the vertical direction).

The processing unit (processor) 3700 performs predetermined processing on position data output from the position synthesis unit (synthesizer) 3600. The resultant is displayed, as a result of the positioning, in the display unit 3900. The position data may be transmitted to an external device by the communication unit 3800.

Hitherto, the vehicle positioning device 3000 is described. As described above, such a vehicle positioning device 3000 includes the inertial measurement unit 3100, the GPS receiving unit (receiving unit (receiver)) 3300 that receives a satellite signal on which position information has been superimposed, from a positioning satellite, the position information acquisition unit (acquisition unit) 3500 that acquires position information of the GPS receiving unit (receiver) 3300 based on the received satellite signal, the arithmetic processing unit (processor) (computation unit) 3200 that calculates the attitude of the vehicle based on inertial navigation positioning data (inertial data) output from the inertial measurement unit 3100, and the position synthesis unit (synthesizer) (calculation unit) 3600 that calculates the position of the vehicle by correcting the position information based on the calculated attitude. Thus, a vehicle positioning device 3000 which is capable of exhibiting the effect of the above-described inertial measurement unit 2000 and has high reliability is obtained.

### Eighteenth Embodiment

Next, an electronic device according to an eighteenth embodiment will be described.

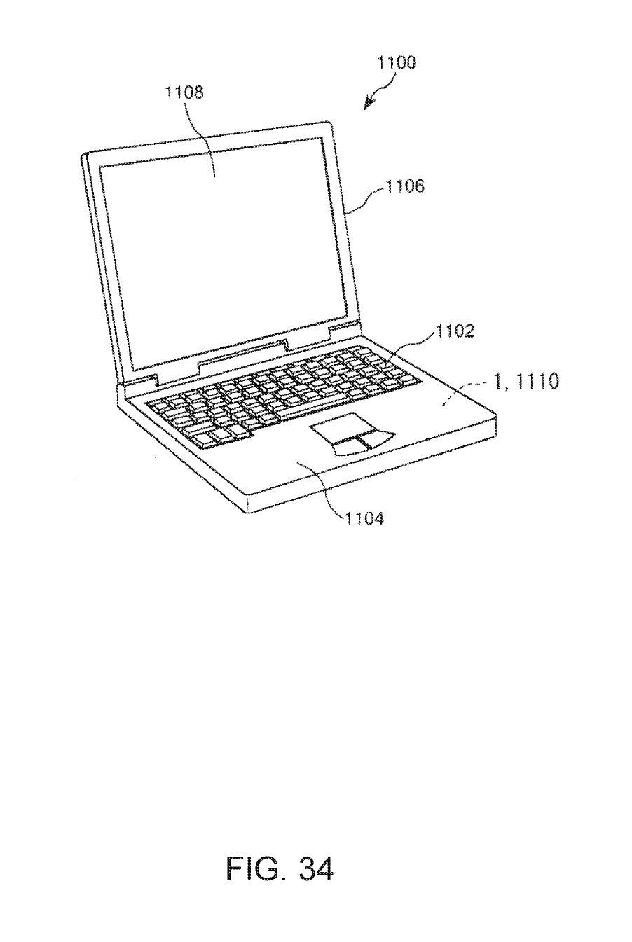

FIG. 34 is a perspective view illustrating the electronic device according to the eighteenth embodiment.

The electronic device in this embodiment is applied to a mobile type (or notebook type) personal computer 1100 illustrated in FIG. 34. The personal computer 1100 includes a main body 1104 including a keyboard 1102 and a display device 1106 including a display unit 1108. The display device 1106 is supported to be allowed to rotate around the main body 1104 by a hinge structure portion. A physical quantity sensor 1 and a control circuit (control unit (controller)) 1110 are mounted in the personal computer 1100. The control circuit 1110 performs control based on a detection signal output from the physical quantity sensor 1. For example, the physical quantity sensor in any of the above-described embodiments can be used as the physical quantity sensor 1.

Such a personal computer (electronic device) 1100 includes the physical quantity sensor 1 and the control circuit (control unit (controller)) 1110 that performs control based on a detection signal output from the physical quantity sensor 1. Therefore, it is possible to exhibit the effect of the above-described physical quantity sensor 1 and to exhibit high reliability.

### Nineteenth Embodiment

Next, an electronic device according to a nineteenth embodiment will be described.

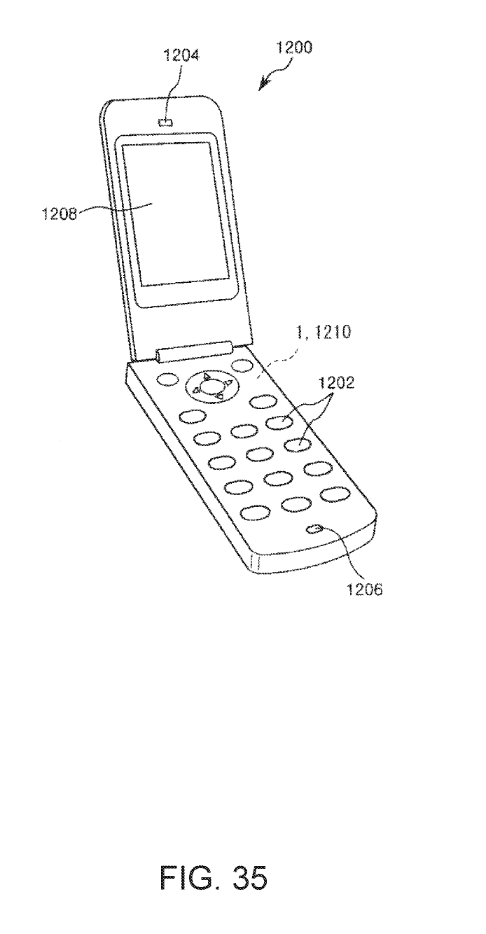

FIG. 35 is a perspective view illustrating the electronic device according to the nineteenth embodiment.

The electronic device in this embodiment is applied to a portable phone 1200 (including a PHS) illustrated in FIG. 35. The portable phone 1200 includes an antenna (not illustrated), a plurality of operation buttons 1202, an earpiece 1204, and a mouthpiece 1206. A display unit 1208 is disposed between the operation button 1202 and the earpiece 1204. A physical quantity sensor 1 and a control circuit (control unit (controller)) 1210 are mounted in the portable phone 1200. The control circuit 1210 performs control based on a detection signal output from the physical quantity sensor 1.

Such a portable phone (electronic device) 1200 includes the physical quantity sensor 1 and the control circuit (control unit (controller)) 1210 that performs control based on a detection signal output from the physical quantity sensor 1. Therefore, it is possible to exhibit the effect of the above-described physical quantity sensor 1 and to exhibit high reliability.

### Twentieth Embodiment

Next, an electronic device according to a twentieth embodiment will be described.

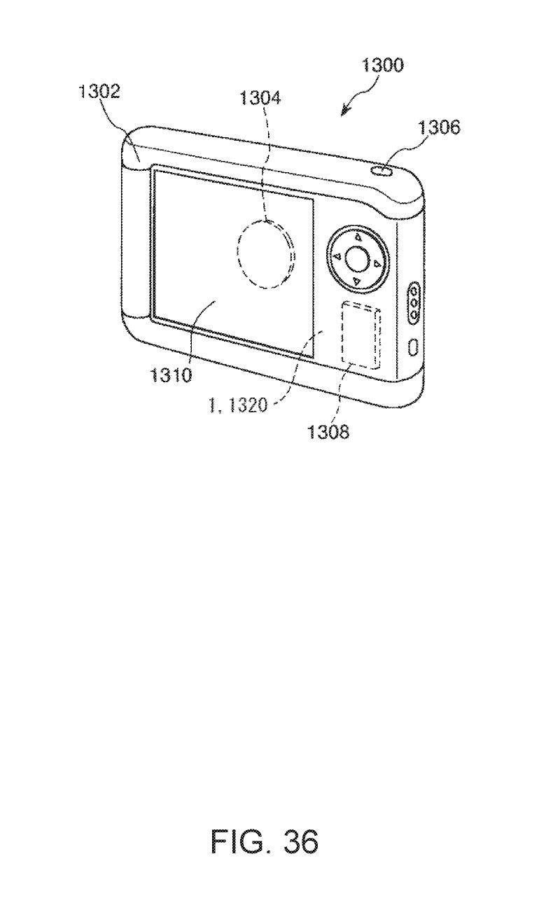

FIG. 36 is a perspective view illustrating the electronic device according to the twentieth embodiment.

The electronic device in this embodiment is applied to a digital still camera 1300 illustrated in FIG. 36. The digital still camera 1300 includes a case 1302. A display unit 1310 is provided on the back surface of the case 1302. The display unit 1310 has a configuration in which display is performed based on an imaging signal obtained by a CCD. The display unit 1310 functions as a viewfinder that displays a subject in a form of an electronic image. A light receiving unit (receiver) 1304 that includes an optical lens (optical imaging system), the CCD, and the like is provided on the front surface side (rear surface side in FIG. 36) of the case 1302. If a photographer checks a subject displayed in the display unit 1310 and pushes the shutter button 1306, an imaging signal at this time is transferred from the CCD and stored in the memory 1308. A physical quantity sensor 1 and a control circuit (control unit (controller)) 1320 are mounted in the digital still camera 1300. The control circuit 1320 performs control based on a detection signal output from the physical quantity sensor 1. The physical quantity sensor 1 is used in image stabilization, for example.

Such a digital still camera (electronic device) 1300 includes the physical quantity sensor 1 and the control circuit (control unit (controller)) 1320 that performs control based on a detection signal output from the physical quantity sensor 1. Therefore, it is possible to exhibit the effect of the above-described physical quantity sensor 1 and to exhibit high reliability.

The electronic device can be applied to, for example, devices as follows in addition to the personal computer and the portable phone in the above-described embodiments and the digital still camera in this embodiment: a smartphone, a tablet terminal, a clock (including a smart watch), an ink jet ejecting apparatus (for example, ink jet printer), a laptop type personal computer, a television, a wearable terminal such as a head mount display (HMD), a video camera, a video tape recorder, a car navigation system, a pager, an electronic notebook (including a type having a communication function), electronic dictionary, an electronic calculator, an electronic game machine, a word processor, a workstation, a video phone, a security television monitor, electronic binoculars, a POS terminal, medical equipment (for example, a clinical electronic thermometer, a blood pressure monitor, a blood glucose meter, an electrocardiogram measuring device, an ultrasonic diagnostic device, and an electronic endoscope), a fish finder, various measuring instruments, equipment for a vehicle terminal and a base station, instruments (for example, instruments of vehicles, aircrafts, ships), a flight simulator, a network server, and the like.

### Twenty-First Embodiment

Next, a portable electronic device according to a twenty-first embodiment will be described.

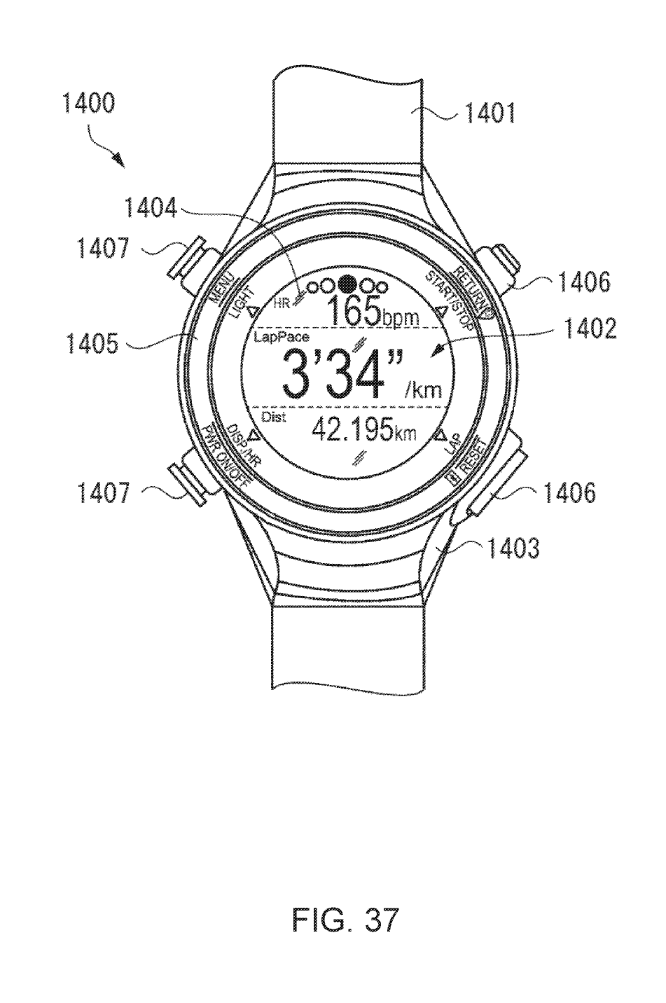

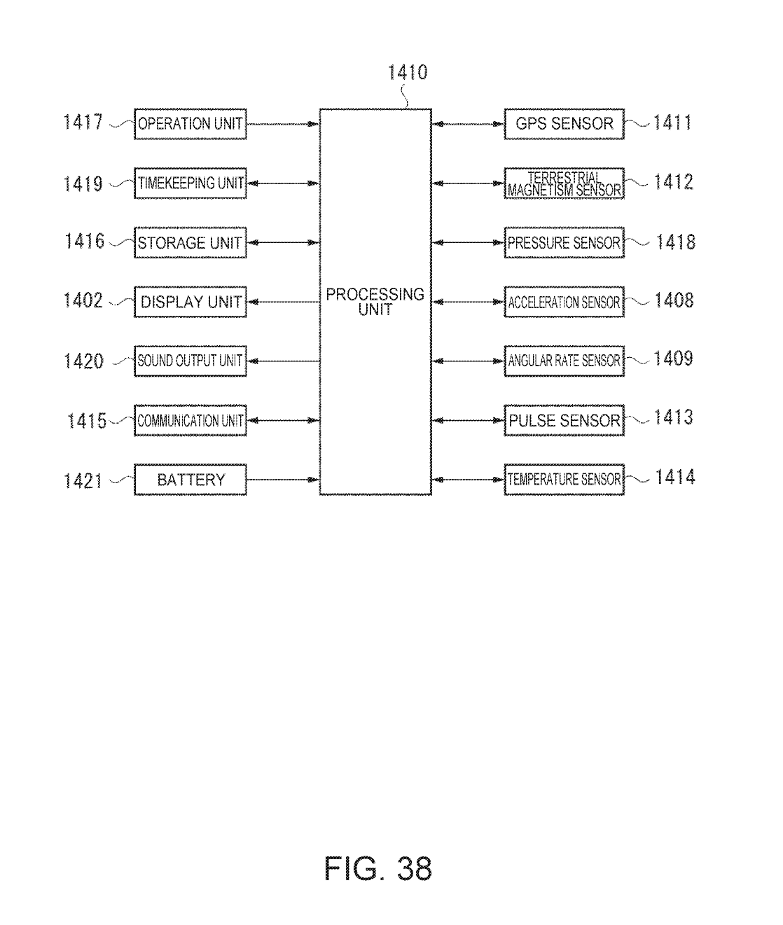

FIG. 37 is a plan view illustrating the portable electronic device according to the twenty-first embodiment. FIG. 38 is a functional block diagram schematically illustrating a configuration of the portable electronic device illustrated in FIG. 37.

A wristwatch type activity meter (active tracker) 1400 illustrated in FIG. 37 is a wrist device to which the portable electronic device in this embodiment has been applied. The activity meter 1400 is mounted on a part (such as a wrist) (detection target) of a user by a band 1401. The activity meter 1400 includes a display unit 1402 in a manner of digital display and is capable of wireless communication. The above-described physical quantity sensor 1 according to the embodiments is incorporated into the activity meter 1400, as an acceleration sensor 1408 that measures an acceleration and an angular rate sensor 1409 that measures an angular rate.

The activity meter 1400 includes a case 1403, a processing unit (processor) 1410, a display unit 1402, and a translucent cover 1404. In the case 1403, the acceleration sensor 1408 and the angular rate sensor 1409 are accommodated. The processing unit (processor) 1410 is accommodated in the case 1403 and processes output data from the acceleration sensor 1408 and the angular rate sensor 1409. The display unit 1402 is accommodated in the case 1403. The translucent cover 1404 closes an opening portion of the case 1403. A bezel 1405 is provided on the outside of the translucent cover 1404. A plurality of operation buttons 1406 and 1407 is provided on the side surface of the case 1403.

As illustrated in FIG. 38, the acceleration sensor 1408 detects an acceleration in each of three axis directions which intersect each other (ideally, orthogonal to each other), and outputs a signal (acceleration signal) depending on the magnitudes and the directions of the detected accelerations in the three axes. The angular rate sensor 1409 detects an angular rate in each of three axis directions which intersect each other (ideally, orthogonal to each other), and outputs a signal (angular rate signal) depending on the magnitudes and the directions of the detected angular rates in the three axes.

In a liquid crystal display (LCD) constituting the display unit 1402, various types of information as follows are displayed in accordance with various detection modes, for example, position information or the movement quantity obtained by using a GPS sensor 1411 or a terrestrial magnetism sensor 1412; motion information such as the momentum, which has been obtained by using the acceleration sensor 1408, the angular rate sensor 1409, or the like; biometric information regarding a pulse rate obtained by using a pulse sensor 1413 or the like; and time information on the current time. An environmental temperature obtained by a temperature sensor 1414 can also be displayed.

A communication unit 1415 performs various controls for establishing a communication between a user terminal and an information terminal (not illustrated). The communication unit 1415 includes, for example, a transmitter-receiver compatible with short-range wireless communication standards such as Bluetooth (registered trademark) (including Bluetooth Low Energy (BTLE)), Wi-Fi (Wireless Fidelity) (registered trademark), Zigbee (registered trademark), NFC (Near field communication), and ANT+ (registered trademark) and a connector compatible with a communication bus standard such as a universal serial bus (USB).

The processing unit (processor) 1410 is configured with, for example, a micro processing unit (MPU), a digital signal processor (DSP), and an application specific integrated circuit (ASIC). The processing unit (processor) 1410 performs various kinds of processing based on a program stored in a storage unit 1416 and a signal input from an operation unit 1417 (For example, operation buttons 1406 and 1407). The processing performed by the processing unit (processor) 1410 includes data processing on output signals from the GPS sensor 1411, the terrestrial magnetism sensor 1412, the pressure sensor 1418, the acceleration sensor 1408, the angular rate sensor 1409, the pulse sensor 1413, the temperature sensor 1414, and a timekeeping unit 1419, display processing of displaying an image in the display unit 1402, sound output processing of outputting sound to a sound output unit 1420, communication processing of performing a communication with an information terminal via the communication unit 1415, power control processing of supplying power from a battery 1421 to the units, and the like.

Such an activity meter 1400 can have at least functions as follows.

1. Distance: measure the total distance from a point in which measuring starts, by a GPS function having high precision

2. Pace: display the current travel pace through pace distance measurement

3. Average speed: calculates an average speed from a point in which traveling at the average speed start to the current point, and display the calculated average speed

4. Altitude: measure and display the altitude by the GPS function

5. Stride: measure and display the stride even in a tunnel where GPS radio waves do not reach

6. Pitch: measure and display the number of steps per one minute

7. Heart rate: measure and display the heart rate by the pulse sensor

8. Gradient: measure and display the gradient of the ground in training and trail runs in the mountains

9. Auto lap: automatically measure lap time when travelling for a predetermined distance or for a predetermined time set in advance

10. Exercise consumed calorie: display calories consumed

11. Number of steps: display the total number of steps from when starting an exercise

Such an activity meter (portable electronic device) 1400 includes the physical quantity sensor 1, the case 1403 in which the physical quantity sensor 1 is accommodated, the processing unit (processor) 1410 which is accommodated in the case 1403 and processes output data from the physical quantity sensor 1, the display unit 1402 accommodated in the case 1403, and the translucent cover 1404 that closes the opening portion of the case 1403. Therefore, it is possible to exhibit the effect of the above-described physical quantity sensor 1 and to exhibit high reliability.

As described above, the activity meter 1400 includes the GPS sensor (satellite positioning system) 1411, and thus can measure a movement distance or a movement trajectory of a user. Therefore, an activity meter 1400 having high convenience is obtained.

The activity meter 1400 can be widely applied to a running watch, a runner's watch, a runner's watch for multisports such as duathlon and triathlon, an outdoor watch, and a GPS watch equipped with a satellite positioning system, for example, a GPS.

The above descriptions are made by using a global positioning system (GPS) as the satellite positioning system. However, other global navigation satellite systems (GNSS) may be used. For example, one, or two or more of satellite positioning systems such as the European geostationary-satellite navigation overlay service (EGNOS), the quasi-zenith satellite system (QZSS), the global navigation satellite system (GLONASS), GALILEO, and the BeiDou navigation satellite system (BeiDou) may be used. A geostationary-satellite type satellite-based augmentation system (SBAS) such as the wide area augmentation system (WAAS) and the European geostationary-satellite navigation overlay service (EGNOS) may be used as at least one satellite positioning system.

### Twenty-Second Embodiment

Next, a vehicle according to a twenty-second embodiment will be described.

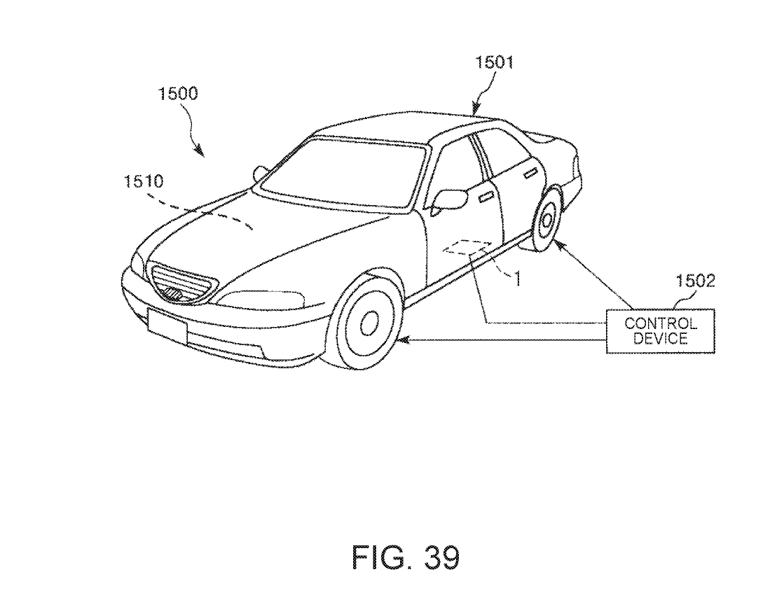

FIG. 39 is a perspective view illustrating the vehicle according to the twenty-second embodiment.

An automobile 1500 illustrated in FIG. 39 is an automobile to which the vehicle in this embodiment has been applied. In FIG. 39, the automobile 1500 includes a system 1510 which is at least one of an engine system, a brake system, and a keyless entry system. The physical quantity sensor 1 is mounted in the automobile 1500, and thus it is possible to detect the attitude of a vehicle body 1501 by the physical quantity sensor 1. A detection signal of the physical quantity sensor 1 is supplied to a control device 1502, and the control device 1502 can control the system 1510 based on the detection signal.

Such an automobile (vehicle) 1500 includes the physical quantity sensor 1 and the control device (control unit (controller)) 1502 that performs control based on a detection signal output from the physical quantity sensor 1. Therefore, it is possible to exhibit the effect of the above-described physical quantity sensor 1 and to exhibit high reliability. The automobile 1500 includes the system 1510 which is at least one of the engine system, the brake system, and the keyless entry system. The control device 1502 controls the system 1510 based on the detection signal. Thus, it is possible to control the system 1510 with high precision.

In addition, the physical quantity sensor 1 can be widely applied to an electronic control unit (ECU) in a car navigation system, a car air conditioner, an antilocking brake system (ABS), an air bag, a tire pressure monitoring system (TPMS), an engine controller, a battery monitor of a hybrid automobile or an electric automobile, and the like.

The vehicle is not limited to the automobile 1500. For example, the vehicle can also be applied to airplanes, rockets, artificial satellites, ships, automated guided vehicles (AGV), bipedal walking robots, and unmanned aircrafts such as drones.

Hitherto, the physical quantity sensor, the physical quantity sensor device, the complex sensor device, the inertial measurement unit, the vehicle positioning device, the portable electronic device, the electronic device, and the vehicle are described based on the embodiments in the drawings. However, the invention is not limited thereto. The components can be substituted with components having the same functions. Any constituent may be added to the invention. The above-described embodiments may be appropriately combined.

In the above-described embodiments, the configuration in which the physical quantity sensor detects an angular rate is described. However, the physical quantity detected by the physical quantity sensor is not particularly limited. For example, an acceleration or pressure may be detected. In the above-described embodiments, the configuration in which the physical quantity sensor 1 is capable of detecting the angular rate about the X axis, the angular rate about the Y axis, and the angular rate about the Z axis is described. However, the invention is not limited thereto. One or two of the angular rates may be omitted. The physical quantity sensor may be capable of detecting plural different kinds of physical quantities (for example, angular rate and acceleration).

What is claimed is:

1. A physical quantity sensor comprising:
a substrate;
a sensor element supported on the substrate; and
a lid bonded to the substrate so as to store the sensor element between the substrate and the lid,
wherein the lid includes a protrusion on the substrate side,
the protrusion is disposed not to overlap the sensor element in plan view of the substrate, and
the protrusion is separated from the substrate or is in contact with the substrate so as to be separable from the substrate.

2. The physical quantity sensor according to claim 1,
wherein the lid includes a recess portion which opens to a main surface on the substrate side and in which at least a portion of the sensor element is disposed, and
the protrusion is provided on a bottom surface of the recess portion.

3. The physical quantity sensor according to claim 1,
wherein the protrusion is separated from the substrate.

4. The physical quantity sensor according to claim 3,
wherein a distance between the protrusion and the substrate is shorter than a distance between the sensor element and a bottom surface of the recess portion.

5. The physical quantity sensor according to claim 4,
wherein the distance between the protrusion and the substrate is from 5 μm to 40 μm.

6. The physical quantity sensor according to claim 5,
wherein the distance between the protrusion and the substrate is from 10 μm to 20 μm.

7. The physical quantity sensor according to claim 3, further comprising:
a bonding member that is positioned between the substrate and the lid and bonds the substrate and the lid to each other,
wherein a gap between the protrusion and the substrate is provided by the bonding member.

8. The physical quantity sensor according to claim 1,
wherein the protrusion includes a tapered portion having a cross-sectional area which decreases from the lid side toward a tip side.

9. The physical quantity sensor according to claim 1,
wherein a groove portion is provided on a tip surface of the protrusion, which faces the substrate.

10. The physical quantity sensor according to claim 1,
wherein a functional film is provided on a tip surface of the protrusion, which faces the substrate.

11. The physical quantity sensor according to claim 1,
wherein a plurality of protrusions is arranged in the lid.

12. A physical quantity sensor comprising:
a substrate;
a sensor element including a fixation portion fixed to the substrate; and
a lid bonded to the substrate so as to store the sensor element between the lid and the substrate,
wherein the lid includes a protrusion on the substrate side,
the protrusion is disposed to overlap the fixation portion in plan view, and
the protrusion is separated from the fixation portion or is in contact with the fixation portion so as to be separable from the fixation portion.

13. A physical quantity sensor comprising:
a substrate;
a sensor element supported on the substrate;
a structural member which is supported on the substrate and is disposed not to overlap the sensor element in plan view; and
a lid bonded to the substrate so as to store the sensor element and the structural member between the lid and the substrate,
wherein the lid includes a protrusion on the substrate side,
the protrusion overlaps the structural member in plan view, and
the protrusion is separated from the structural member or is in contact with the structural member so as to be separable from the structural member.

14. The physical quantity sensor according to claim 13,
wherein the structural member is disposed to surround at least a portion of the sensor element in plan view.

15. A physical quantity sensor device comprising:
the physical quantity sensor according to claim 1; and
a circuit element.

16. The physical quantity sensor device according to claim 15, further comprising:
a package that stores the physical quantity sensor and the circuit element.

17. A physical quantity sensor device comprising:
the physical quantity sensor according to claim 1; and
a resin package that covers the physical quantity sensor.

18. A complex sensor device comprising:
a first physical quantity sensor which is a physical quantity sensor according to claim 1; and
a second physical quantity sensor that detects a physical quantity different from that detected by the first physical quantity sensor.

19. An electronic device comprising:
the physical quantity sensor according to claim 1; and
a controller that performs a control based on a detection signal output from the physical quantity sensor.

20. A vehicle comprising:
the physical quantity sensor according to claim 1; and
a controller that performs a control based on a detection signal output from the physical quantity sensor.
